SEQUENCE LISTING (40 sequences)

SEQ ID NO: 1 - DNA, 25 bp, Homo sapiens
gccatcggtacgaactcaatgatgt

SEQ ID NO: 2 - DNA, 25 bp, Homo sapiens
gccatcggtacgcactcaatgatgt

SEQ ID NO: 3 - DNA, 25 bp, Homo sapiens
gccatcggtacggactcaatgatgt

SEQ ID NO: 4 - DNA, 25 bp, Homo sapiens
gccatcggtacgtactcaatgatgt

SEQ ID NO: 5 - DNA, 25 bp, Homo sapiens
catcggtacgtaatcaatgatgtcg

SEQ ID NO: 6 - DNA, 25 bp, Homo sapiens
catcggtacgaagtcaatgatgtcg

SEQ ID NO: 7 - DNA, 25 bp, Homo sapiens
catcggtacgaattcaatgatgtcg

SEQ ID NO: 8 - DNA, 25 bp, Homo sapiens
catcggtacgaactcaatgatgtcg

SEQ ID NO: 9 - DNA, 32 bp, Homo sapiens
atcggtagccatgcatgagttactacagctca

SEQ ID NO: 10 - DNA, 32 bp, Homo sapiens
tagccatcggtacgtactcaatgatgtcgagt

SEQ ID NO: 11 - DNA, 25 bp, Homo sapiens
ggtagccatgcatgagttactacag

SEQ ID NO: 12 - DNA, 25 bp, Homo sapiens
ggtagccatgcaagagttactacag

SEQ ID NO: 13 - DNA, 25 bp, Homo sapiens
ggtagccatgcacgagttactacag

SEQ ID NO: 14 - DNA, 25 bp, Homo sapiens
ggtagccatgcaggagttactacag

SEQ ID NO: 15 - DNA, 25 bp, Homo sapiens
tagccatgcatgagttactacagct

SEQ ID NO: 16 - DNA, 25 bp, Homo sapiens
tagccatgcatgcgttactacagct

SEQ ID NO: 17 - DNA, 25 bp, Homo sapiens
tagccatgcatgggttactacagct

SEQ ID NO: 18 - DNA, 25 bp, Homo sapiens
tagccatgcatgtgttactacagct

SEQ ID NO: 19 - DNA, 25 bp, Homo sapiens
gccatcggtacgaactcaatgatgt

SEQ ID NO: 20 - DNA, 25 bp, Homo sapiens
gccatcggtacgcactcaatgatgt

SEQ ID NO: 21 - DNA, 25 bp, Homo sapiens
gccatcggtacggactcaatgatgt

SEQ ID NO: 22 - DNA, 25 bp, Homo sapiens
gccatcggtacgtactcaatgatgt

SEQ ID NO: 23 - DNA, 25 bp, Homo sapiens
gccatcggtacgtactcgatgatgt

SEQ ID NO: 24 - DNA, 25 bp, Homo sapiens
catcggtacgtaatcaatgatgtcg

SEQ ID NO: 25 - DNA, 25 bp, Homo sapiens
catcggtacgaagtcaatgatgtcg

SEQ ID NO: 26 - DNA, 25 bp, Homo sapiens
catcggtacgaattcaatgatgtcg

SEQ ID NO: 27 - DNA, 25 bp, Homo sapiens
catcggtacgaactcaatgatgtcg

SEQ ID NO: 28 - DNA, 25 bp, Homo sapiens
catcggtacgaactcgatgatgtcg

SEQ ID NO: 29 - DNA, 32 bp, Homo sapiens
atcggtagccatgcatgagctactacagctca

SEQ ID NO: 30 - DNA, 32 bp, Homo sapiens; identical to SEQ ID NO: 10

SEQ ID NO: 31 - DNA, 25 bp, Homo sapiens
ggtagccatgcatgagttactacag

SEQ ID NO: 32 - DNA, 25 bp, Homo sapiens
ggtagccatgcatgagctactacag

SEQ ID NO: 33 - DNA, 25 bp, Homo sapiens
ggtagccatgcaagagttactacag

SEQ ID NO: 34 - DNA, 25 bp, Homo sapiens
ggtagccatgcacgagttactacag

SEQ ID NO: 35 - DNA, 25 bp, Homo sapiens
ggtagccatgcaggagttactacag

SEQ ID NO: 36 - DNA, 25 bp, Homo sapiens
tagccatgcatgagttactacagct

SEQ ID NO: 37 - DNA, 25 bp, Homo sapiens
tagccatgcatgagctactacagct

SEQ ID NO: 38 - DNA, 25 bp, Homo sapiens
tagccatgcatgcgttactacagct

SEQ ID NO: 39 - DNA, 25 bp, Homo sapiens
tagccatgcatgggttactacagct

SEQ ID NO: 40 - DNA, 25 bp, Homo sapiens
tagccatgcatgtgttactacagct

(19) United States
(12) Patent Application Publication
(10) Pub. No.: US 2009/0233809 A1
(43) Pub. Date: Sep. 17, 2009

(54) RESEQUENCING METHODS FOR IDENTIFICATION OF SEQUENCE VARIANTS

(75) Inventors: Malek Faham, Pacifica, CA (US); Jianbiao Zheng, Fremont, CA (US)

Correspondence Address: AFFYMETRIX, INC;ATTN: CHIEF IP COUNSEL, LEGAL DEPT., 3420 CENTRAL EXPRESSWAY, SANTA CLARA, CA, 95051, US

(73) Assignee: Affymetrix, Inc., Santa Clara, CA (US)

(21) Appl. No.: 12/398,177

(22) Filed: Mar. 4, 2009

Related U.S. Application Data
(60) Provisional application No. 61/033,561, filed on Mar. 4, 2008.

(51) Int. Cl. C40B 30/04; C40B 40/08

(52) U.S. Cl. 506/9; 506/17

(57) ABSTRACT

Methods for detection of variant alleles are disclosed. In preferred aspects variants are detected by hybridization patterns to arrays of probes that are contain a single mismatch to a reference sequence, thus reducing the number of probes needed for resequencing by hybridization. The target capture method used is Target Amplification by Capture and Ligation (TACL), and is capable of amplifying many thousands of loci together. Mismatch Repair Detection (MRD) is used as an allele enrichment method to efficiently sort variant and non-variant alleles in thousands of loci simultaneously.

This application claims priority to provisional application No. 61/033,561 filed Mar. 4, 2008, the entire disclosure of which is incorporated herein by reference.

### BACKGROUND OF THE INVENTION

Genetic variability has a large contribution to common disease. It is expected that a large proportion of common disease variability can be explained by heredity. There had been much debate about the allele frequency distribution of the disease causing alleles with some predicting the preponderance of common alleles and others of rare ones. It has also been reported that the presence of common alleles with high genotypic relative risk (GRR) for specific common diseases is inconsistent with the lack of robust associations in linkage studies for these diseases. On the other hand, rare alleles may have high GRR. Recently the advent of high throughput genotyping technologies has allowed whole genome associations of common disease with common alleles. Several large studies with 1,000s and 10,000s of samples led to successful and reproducible associations. The vast majority of these have low GRR (less than 1.5) and many have GRR less than 1.2. Unfortunately, the identified associations explain only a small fraction of the genetic contribution to common disease. The major part of this contribution can be due to common alleles with even smaller GRR requiring studies with larger sample sizes than already performed. Alternatively, rare alleles may be the major contributor to common disease. In spite of the lack of whole genome surveys for associations of rare alleles with common disease, several associations have already been identified. Development of high throughput resequencing technologies will allow a more systematic approach for the identification of rare alleles contributing to common disease.

### SUMMARY OF THE INVENTION

Methods for resequencing collections of targets of interest are disclosed herein. The methods facilitate the study of large numbers of genomic samples at high accuracy for the identification of novel alleles that may account for disease susceptibility but be relatively rare in a given population.

The methods use array based platforms combined with enrichment methods and enzymatic genotyping methods to achieve increased efficiency.

In one embodiment methods are disclosed for resequencing target sequences by hybridization to probes complementary to a wild type reference sequence, but instead of including probes that are a perfect match to the reference sequence each probe has a mismatch. In a preferred aspect the probes each contain a single mismatch at a central position, for example, position 13 of a 25 base probe.

In one embodiment there are three different mismatch probes for each interrogation position, one for each of the three bases that are not a perfect match to the reference at that position. In another aspect there is a single probe for each interrogation position, having one of the three bases that are not a perfect match to the reference at that position. The wild type sequence hybridizes to each probe with a single mismatch so the intensity is less than it would be if the probes were a perfect match. If there is a variant, the probes of the array that span the region containing the variant will have two mismatches, except for the probe that has a mismatch from wild type at the same position as the variant and that probe will either have a single mismatch or no mismatches.

In preferred embodiments methods for determining the location of one or more variations from a reference sequence in a target nucleic acid are disclosed. The methods include amplification and enrichment of the variant containing sequence. The amplified and enriched targets are hybridized to a resequencing array that contains only mismatch probes. The probes contain a single mismatch at a central position that is a mismatch to the reference sequence. The array contains probes to interrogate preferably each base in the target to be analyzed. Preferably the array contains probes to interrogate multiple targets. Each probe in a probe set for a given interrogation position is perfectly complementary to one possible variant at that position. The hybridization pattern is analyzed to identify the location of variants and to determine what base is present at the variant position.

### BRIEF DESCRIPTION OF THE DRAWINGS

The above and other objects and advantages of the present invention will be apparent upon consideration of the following detailed description taken in conjunction with the accompanying drawings, in which like characters refer to like parts throughout, and in which:

FIG. 1 is a schematic of a method of synthesizing dU probes by target specific PCR in the presence of dUTP.

FIG. 2 is a schematic of one embodiment of TACL.

FIG. 3 is a schematic of TACL using 5′ flap endonuclease.

FIG. 4 shows a plot of ratio versus amplicon size on the left or flap size on the right.

FIG. 5A shows example probe sets for a design that included PM and MM and targets alternating strands.

FIG. 5B shows example probe sets as in FIG. 5A but where there is a known SNP.

FIG. 6A shows a plot of signal versus base position for a single amplicon in 19 different samples

FIG. 6B shows the fit for the footprint model and the data from the VP of each strand, showing a dip around the site of a variant.

FIG. 7 shows a method of TACL using chemically synthesized dUPs and looping out of the central region of the target.

FIG. 8A shows a reduction in signal due to loss of hybridization and ligation as detected with forward strand probes only.

FIG. 8B shows a reduction in signal due to loss of hybridization and ligation as detected with reverse strand probes only.

FIG. 9 shows a flowchart of the analysis of a 96 well plate of genomic DNA.

FIG. 10 shows example probe sets using only MM probes to detect variants.

FIG. 11 shows a model plot of the expected hybridization intensity for a probe set design using only mismatch probes.

### DETAILED DESCRIPTION OF THE INVENTION

### General

The present invention has many preferred embodiments and relies on many patents, applications and other references for details known to those of the art. Therefore, when a patent, application, or other reference is cited or repeated below, it should be understood that it is incorporated by reference in its entirety for all purposes as well as for the proposition that is recited.

As used in this application, the singular form “a,” “an,” and “the” include plural references unless the context clearly dictates otherwise. For example, the term “an agent” includes a plurality of agents, including mixtures thereof.

An individual is not limited to a human being, but may also include other organisms including but not limited to mammals, plants, fungi, bacteria or cells derived from any of the above.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995) Biochemistry (4th Ed.) Freeman, New York, Gait, “Oligonucleotide Synthesis: A Practical Approach” 1984, IRL Press, London, Nelson and Cox (2000), Lehninger, Principles of Biochemistry 3^{rd} Ed., W.H. Freeman Pub., New York, N.Y. and Berg et al. (2002) Biochemistry, 5^{th} Ed., W.H. Freeman Pub., New York, N.Y., all of which are herein incorporated in their entirety by reference for all purposes.

The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, in PCT Applications Nos. PCT/US99/00730 (International Publication No. WO 99/36760) and PCT/US01/04285 (International Publication No. WO 01/58593), which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165, and 5,959,098. Nucleic acid arrays are described in many of the above patents, but the same techniques are applied to polypeptide arrays.

Nucleic acid arrays that are useful in the present invention include those that are commercially available from Affymetrix (Santa Clara, Calif.) under the brand name GeneChip®. Example arrays are shown on the website at affymetrix.com.

The present invention also contemplates many uses for polymers attached to solid substrates. These uses include gene expression monitoring, profiling, library screening, genotyping and diagnostics. Gene expression monitoring and profiling methods can be shown in U.S. Pat. Nos. 5,800,992, 6,013,449, 6,020,135, 6,033,860, 6,040,138, 6,177,248 and 6,309,822. Genotyping and uses therefore are shown in U.S. Ser. Nos. 10/442,021, 10/013,598 (U.S. Patent Application Publication 20030036069), and U.S. Pat. Nos. 5,856,092, 6,300,063, 5,858,659, 6,284,460, 6,361,947, 6,368,799 and 6,333,179. Other uses are embodied in U.S. Pat. Nos. 5,871,928, 5,902,723, 6,045,996, 5,541,061, and 6,197,506.

The present invention also contemplates sample preparation methods in certain preferred embodiments. Prior to or concurrent with hybridization to an array, the sample may be amplified by a variety of mechanisms, some of which may employ PCR. See, for example, PCR Technology: Principles and Applications for DNA Amplification (Ed. H. A. Erlich, Freeman Press, NY, N.Y., 1992); PCR Protocols: A Guide to Methods and Applications (Eds. Innis, et al., Academic Press, San Diego, Calif., 1990); Mattila et al., Nucleic Acids Res. 19, 4967 (1991); Eckert et al., PCR Methods and Applications 1, 17 (1991); PCR (Eds. McPherson et al., IRL Press, Oxford); and U.S. Pat. Nos. 4,683,202, 4,683,195, 4,800,159, 4,965,188, and 5,333,675. The sample may be amplified on the array. See, for example, U.S. Pat. No. 6,300,070 which is incorporated herein by reference.

Other suitable amplification methods include the ligase chain reaction (LCR) (for example, Wu and Wallace, Genomics 4, 560 (1989), Landegren et al., Science 241, 1077 (1988) and Barringer et al. Gene 89:117 (1990)), transcription amplification (Kwoh et al., Proc. Natl. Acad. Sci. USA 86, 1173 (1989) and WO88/10315), self-sustained sequence replication (Guatelli et al., Proc. Nat. Acad. Sci. USA, 87, 1874 (1990) and WO90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5,413,909, 5,861,245), rolling circle amplification (RCA) (for example, Fire and Xu, PNAS 92:4641 (1995) and Liu et al., J. Am. Chem. Soc. 118:1587 (1996)) and nucleic acid based sequence amplification (NABSA), (See, U.S. Pat. Nos. 5,409,818, 5,554,517, and 6,063,603).

Other amplification methods that may be used are described in, U.S. Pat. Nos. 5,242,794, 5,494,810, 4,988,617 and in U.S. Ser. No. 09/854,317. Other amplification methods are also disclosed in Dahl et al., Nuc. Acids Res. 33(8):e71 (2005) and circle to circle amplification (C2CA) Dahl et al., PNAS101:4548 (2004). Locus specific amplification and representative genome amplification methods may also be used.

Additional methods of sample preparation and techniques for reducing the complexity of a nucleic sample are described in Dong et al., Genome Research 11, 1418 (2001), in U.S. Pat. Nos. 6,872,529, 6,361,947, 6,391,592 and 6,107,023, US Patent Publication Nos. 20030096235 and 20030082543 and U.S. patent application Ser. No. 09/916,135.

Methods for conducting polynucleotide hybridization assays have been well developed in the art. Hybridization assay procedures and conditions will vary depending on the application and are selected in accordance with the general binding methods known including those referred to in: Maniatis et al. Molecular Cloning: A Laboratory Manual (2nd Ed. Cold Spring Harbor, N.Y., 1989); Berger and Kimmel Methods in Enzymology, Vol. 152, Guide to Molecular Cloning Techniques (Academic Press, Inc., San Diego, Calif., 1987); Young and Davism, P.N.A.S, 80: 1194 (1983). Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference.

The present invention also contemplates signal detection of hybridization between ligands in certain preferred embodiments. See U.S. Pat. Nos. 5,143,854, 5,578,832; 5,631,734; 5,834,758; 5,936,324; 5,981,956; 6,025,601; 6,141,096; 6,185,030; 6,201,639; 6,218,803; and 6,225,625, in U.S. Ser. No. 10/389,194 and in PCT Application PCT/US99/06097 (published as WO99/47964), each of which also is hereby incorporated by reference in its entirety for all purposes.

Methods and apparatus for signal detection and processing of intensity data are disclosed in, for example, U.S. Pat. Nos. 5,143,854, 5,547,839, 5,578,832, 5,631,734, 5,800,992, 5,834,758; 5,856,092, 5,902,723, 5,936,324, 5,981,956, 6,025,601, 6,090,555, 6,141,096, 6,185,030, 6,201,639; 6,218,803; and 6,225,625, in U.S. Ser. Nos. 10/389,194, 60/493,495 and in PCT Application PCT/US99/06097 (published as WO 99/47964), each of which also is hereby incorporated by reference in its entirety for all purposes. Instruments and software may also be purchased commercially from various sources, including Affymetrix.

The practice of the present invention may also employ conventional biology methods, software and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, for example Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2nd ed., 2001). See U.S. Pat. No. 6,420,108.

Methods for detection of methylation status are disclosed, for example, in Fraga and Esteller, BioTechniques 33:632-649 (2002) and Dahl and Guldberg Biogerontology 4:233-250 (2003). Methylation detection using bisulfite modification and target specific PCR have been disclosed, for example, in U.S. Pat. Nos. 5,786,146, 6,200,756, 6,143,504, 6,265,171, 6,251,594, 6,331,393, and 6,596,493.

U.S. Pat. No. 6,884,586 disclosed methods for methylation analysis using nicking agents and isothermal amplification.

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170.

Additionally, the present invention may have preferred embodiments that include methods for providing genetic information over networks such as the Internet as shown in U.S. Ser. Nos. 10/197,621, 10/063,559 (United States Publication No. 20020183936), 10/065,856, 10/065,868, 10/328,818, 10/328,872, 10/423,403, and 60/482,389.

All documents, i.e., publications and patent applications, cited in this disclosure, including the foregoing, are incorporated by reference herein in their entireties for all purposes to the same extent as if each of the individual documents were specifically and individually indicated to be so incorporated by reference herein in its entirety.

### DEFINITIONS

“Adaptor sequences” or “adaptors” are generally oligonucleotides of at least 5, 10, or 15 bases and preferably no more than 50 or 60 bases in length; however, they may be even longer, up to 100 or 200 bases. Adaptor sequences may be synthesized using any methods known to those of skill in the art. For the purposes of this invention they may, as options, comprise primer binding sites, recognition sites for endonucleases, common sequences and promoters. The adaptor may be entirely or substantially double stranded or entirely single stranded. A double stranded adaptor may comprise two oligonucleotides that are at least partially complementary. The adaptor may be phosphorylated or unphosphorylated on one or both strands.

Adaptors may be more efficiently ligated to fragments if they comprise a substantially double stranded region and a short single stranded region which is complementary to the single stranded region created by digestion with a restriction enzyme. For example, when DNA is digested with the restriction enzyme EcoRI the resulting double stranded fragments are flanked at either end by the single stranded overhang 5′-AATT-3′, an adaptor that carries a single stranded overhang 5′-AATT-3′ will hybridize to the fragment through complementarity between the overhanging regions. This “sticky end” hybridization of the adaptor to the fragment may facilitate ligation of the adaptor to the fragment but blunt ended ligation is also possible. Blunt ends can be converted to sticky ends using the exonuclease activity of the Klenow fragment. For example when DNA is digested with PvuII the blunt ends can be converted to a two base pair overhang by incubating the fragments with Klenow in the presence of dTTP and dCTP. Overhangs may also be converted to blunt ends by filling in an overhang or removing an overhang.

Methods of ligation will be known to those of skill in the art and are described, for example in Sambrook et at. (2001) and the New England BioLabs catalog both of which are incorporated herein by reference for all purposes. Methods include using T4 DNA Ligase which catalyzes the formation of a phosphodiester bond between juxtaposed 5′ phosphate and 3′ hydroxyl termini in duplex DNA or RNA with blunt and sticky ends; Taq DNA Ligase which catalyzes the formation of a phosphodiester bond between juxtaposed 5′ phosphate and 3′ hydroxyl termini of two adjacent oligonucleotides which are hybridized to a complementary target DNA; E. coli DNA ligase which catalyzes the formation of a phosphodiester bond between juxtaposed 5′-phosphate and 3′-hydroxyl termini in duplex DNA containing cohesive ends; and T4 RNA ligase which catalyzes ligation of a 5′ phosphoryl-terminated nucleic acid donor to a 3′ hydroxyl-terminated nucleic acid acceptor through the formation of a 3′->5′ phosphodiester bond, substrates include single-stranded RNA and DNA as well as dinucleoside pyrophosphates; or any other methods described in the art. Fragmented DNA may be treated with one or more enzymes, for example, an endonuclease, prior to ligation of adaptors to one or both ends to facilitate ligation by generating ends that are compatible with ligation.

Adaptors may also incorporate modified nucleotides that modify the properties of the adaptor sequence. For example, phosphorothioate groups may be incorporated in one of the adaptor strands. A phosphorothioate group is a modified phosphate group with one of the oxygen atoms replaced by a sulfur atom. In a phosphorothioated oligo (often called an “S-Oligo”), some or all of the internucleotide phosphate groups are replaced by phosphorothioate groups. The modified backbone of an S-Oligo is resistant to the action of most exonucleases and endonucleases. Phosphorothioates may be incorporated between all residues of an adaptor strand, or at specified locations within a sequence. A useful option is to sulfurize only the last few residues at each end of the oligo. This results in an oligo that is resistant to exonucleases, but has a natural DNA center.

The term “array” as used herein refers to an intentionally created collection of molecules which can be prepared either synthetically or biosynthetically. The molecules in the array can be identical or different from each other. The array can assume a variety of formats, for example, libraries of soluble molecules; libraries of compounds tethered to resin beads, silica chips, or other solid supports.

The term “epigenetic” as used herein refers to factors other than the primary sequence of the genome that affect the development or function of an organism, they can affect the phenotype of an organism without changing the genotype. Epigenetic factors include modifications in gene expression that are controlled by heritable but potentially reversible changes in DNA methylation and chromatin structure. Methylation patterns are known to correlate with gene expression and in general highly methylated sequences are poorly expressed.

The term “genome” as used herein is all the genetic material in the chromosomes of an organism. DNA derived from the genetic material in the chromosomes of a particular organism is genomic DNA. A genomic library is a collection of clones made from a set of randomly generated overlapping DNA fragments representing the entire genome of an organism.

Restriction enzymes or restriction endonucleases and their properties are well known in the art. A wide variety of restriction enzymes are commercially available, from, for example, New England Biolabs. Restriction enzymes recognize a sequence specific sites (recognition site) in DNA. Typically the recognition site varies from enzyme to enzyme and may also vary in length. Isoschizomers are enzymes that share the same recognition site. Restriction enzymes may cleave close to or within their recognition site or outside of the recognition site. Often the recognition site is symmetric because the enzyme binds the double stranded DNA as homodimers.

Recognition sequences may be continuous or may be discontinuous, for example, two half sites separated by a variable region. Cleavage can generate blunt ends or short single stranded overhangs.

The terms “solid support”, “support”, and “substrate” as used herein are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. See U.S. Pat. No. 5,744,305 for exemplary substrates.

“Specific binding” refers to the ability of two molecular species concurrently present in a heterogeneous (inhomogeneous) sample to bind to one another in preference to binding to other molecular species in the sample. Typically, a specific binding interaction will discriminate over adventitious binding interactions in the reaction by at least two-fold, more typically by at least 10-fold, often at least 100-fold. Typically, the affinity or avidity of a specific binding reaction is least about 10⁷ M⁻¹, using at least 10⁸ M⁻¹ to at least about 10⁹ M⁻¹, and often greater, including affinities or avidities up to 10¹⁰ M⁻¹ to 10¹² M⁻¹.

A central position herein refers to a base at the center of a probe, for example, position 13 of a 25 base probe or position 13 or 14 of a 26 base probe, so that the number of bases on either side of the central position (not including the central position) is either equal, for example, 12 on either side of the central position of a 25 mer, or varies by no more than 1 base, for example, 12 and 13 on either side of the central position of a 26 mer.

Many of the embodiments described below employ methods of capturing a population of pre-selected target sequences from a genomic DNA sample, for example, target amplification by capture and ligation or TACL (“tackle”). In some aspects the methods rely on dU probe technology as previously disclosed in US Patent Application No. 20030096291 and U.S. Pat. No. 7,208,295. Additional methods for making and using dU probes are also disclosed in 60/887,546 filed Jan. 31, 2007. Briefly, dU probes may be generated by performing PCR using a pair of primers for each target sequence. Each primer contains a target specific region in the 3′ portion and a 5′ common sequence. The PCR is performed in the presence of dUTP so uracil is incorporated into the amplification product. The amplicons from different reactions can be pooled and amplified as a single reaction using primers to the common regions in the primers. This results in a pool of dU probes for a collection of target sequences. The pool need only be generated once and aliquots can be used for amplification of the targets from different samples. To use the dU probes an aliquot is mixed with the target sample which has preferably been fragmented to generate ends that are compatible with the target specific region of the dU probes. Sequences complementary to the common regions are also added. The dU probe acts like a splint and the target sequence from the sample is ligated to the common regions and can then be amplified using common primers. These methods allow for amplification of a limited number of specific target sequences from a complex background, for example, 100 to 2,000 different exons of interest from genes of interest or promoter regions of interest can be amplified from human genomic DNA. The sequence of the dU probes determines what sequences will be amplified and variation in the target, for example, polymorphisms that are present in the sample but were not present in the nucleic acid used to generate the dU probes, still allow for amplification of the sequence in the target.

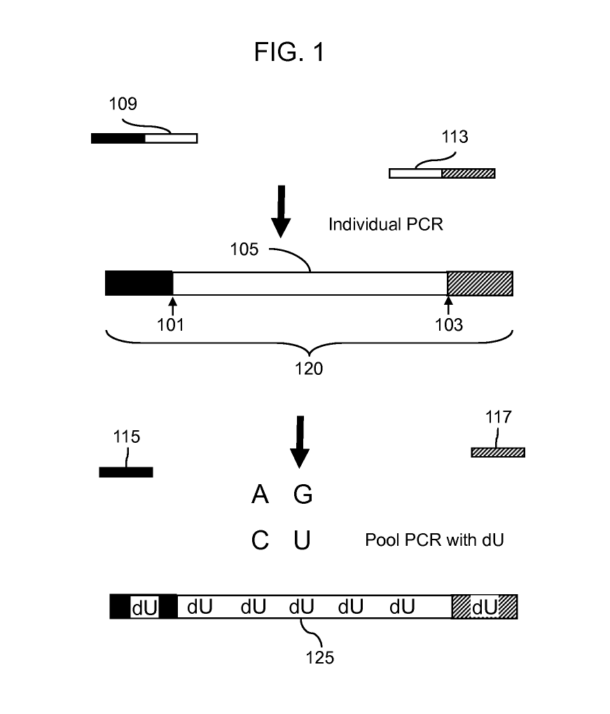

TACL uses probes to capture specific sequences of interest. The probes are called dU probes or dUPs. dUPs are double stranded DNA containing sequences unique to each dUP flanked by two sequences common to all dUPs (FIG. 1). The unique sequences range in size between 70-350 bp, with an average size of ˜160 bp. These unique sequences are the same as those to be captured from the genome except that all the deoxythymidine triphosphate (dTTP) in the dUP sequences are replaced by deoxyuridine triphosphate (dUTP).

As shown in FIG. 1, a selected target sequence 105 with defined end bases at 101 and 103 is amplified from a larger sequence using locus specific primer extension using primers 109 and 113. The resulting template 120 has ends that are defined by the sequence of oligonucleotide primers 109 and 113 and has common priming sites flanking the target region of interest. The template can be amplified using primers 115 and 117 in the presence of dUTP in place of dTTP to obtain dU probe 125 (dUP). Many individual PCRs can be performed and pooled then amplified using primers to the common priming sites.

In order to make the dUPs, individual PCR reactions to amplify the target sequences of interest are performed. Each 1,000 of these PCR reactions are then pooled, diluted, and amplified again using common primers that were present on the ends of all the amplicons. In this second PCR reaction, dTTP is used instead of dUTP leading to global removal of all the Ts in the sequence and replacing it with Us.

This process for making the dUPs is labor intensive since the first PCR performed is an individual PCR reaction for each locus. However, this process needs only to be performed once and the panel that is generated can be used with every sample studied. In addition methods for eliminating the labor intensive aspect of making the dUPs are also disclosed.

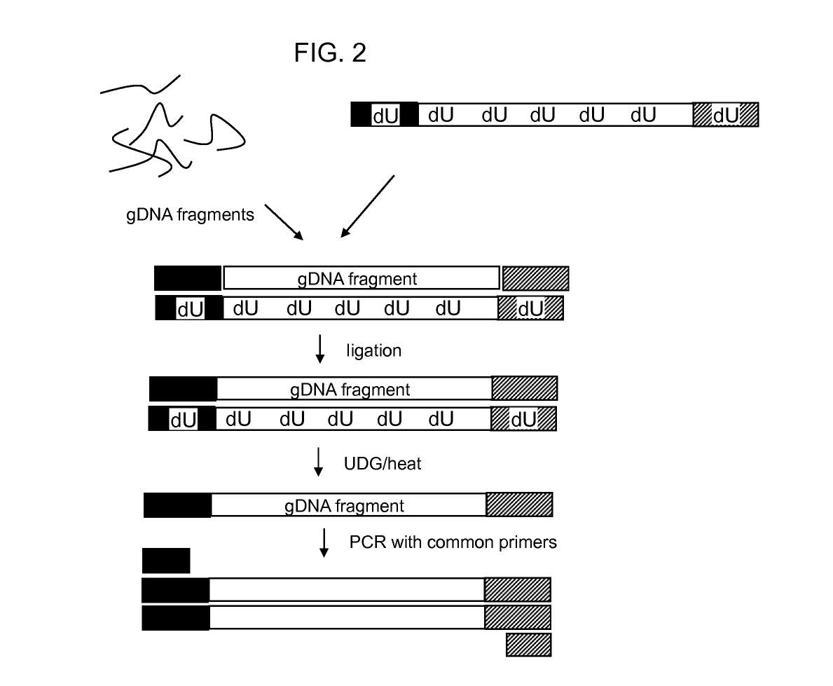

The dUP pools are used to capture the sequences of interest from genomic DNA. This is achieved through hybridization of the dUPs, common oligonucleotides, and digested genomic DNA as shown in FIG. 2. The hybridization generates a structure where one strand comes from the dUP and the other from the common primers and genomic DNA. If the genomic DNA digestion generates ends that match the end of the dUP, then the structure is a perfect double stranded structure with two nicks. These nicks can be closed through the use of thermostable ligase resulting in connecting common primers to the genomic sequences that are captured. Then UDG is used to digest the dUPs rendering them unamplifiable. Later amplification of the all the captured sequences is done by PCR using the common primers.

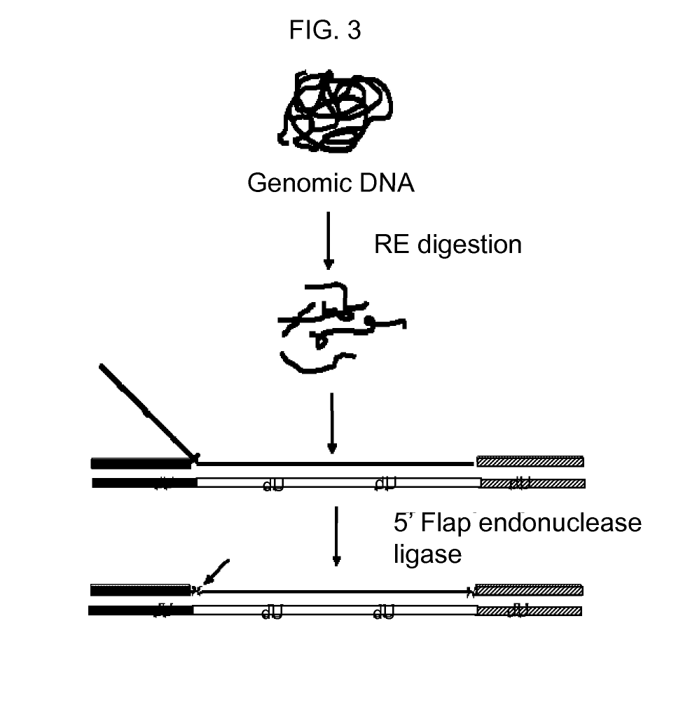

One element of the above procedure is that the ends of the dUPs need to match restriction enzyme ends. This leads to a limitation in the flexibility of the design and coverage of exons of interest. To ameliorate this problem one end can be allowed not to be an end of a restriction fragment end. In that case the structure generated after hybridization of the genomic sequence to the dUP has a flap on one side (FIG. 3). The use of a 5′ flap endonuclease makes the structure double stranded with two nicks that can be sealed using a thermostable ligase. The use of 5′ flap greatly increases the flexibility while maintaining the efficiency of the procedure.

The fraction of exonic bases that are covered by amplicons 70-350 bp in size with and without the flap was computed. Whereas not using the flap allows only ˜50% of the bases to be covered, ˜84% of the exonic bases can be covered with one enzyme while using a flap. The use of three enzymes increases the coverage to 99% of the exonic bases.

The probes can be used to capture targets from a sample being studied. DNA captured by these methods can be used for a variety of purposes, including, for example, methylation analysis, genotyping analysis, resequencing analysis, copy number analysis, haplotype analysis, and variant detection. The captured DNA is ligated to common priming sequences at the 5′ and 3′ ends of the captured genomic DNA to facilitate amplification. The captured DNA can be treated prior to amplification with the common primers, for example, the DNA can be bisulfite modified to preserve an indication of methylation status. Other treatments are also possible, for example, the captured DNA may be subjected to an affinity separation prior to amplification. For example, 5 meC containing captured DNA may be isolated using an antibody to 5 meC and one or both fractions may be subsequently amplified.

In preferred aspects, a collection of template probes corresponding to a collection of targets of interest are used as template to facilitate the ligation of common priming sequences to the ends of the target sequences in a nucleic acid sample to be analyzed. After the ligation, the template probes are digested or separated so they are not targets for subsequence amplification. The target sequences can then be amplified from the nucleic acid sample being analyzed and the amplification product can be interrogated.

Each template probe is complementary to a different target of interest flanked by a priming sequence at the 5′ end and a second priming sequence at the 3′ end. The targets are allowed to hybridize to the corresponding template probe and common priming sequences are ligated to the ends of the target in a subsequent step. The template probes are removed, for example, by digestion and the targets are amplified using primers to the common priming sequences. Non-targets do not have the common priming sequences so they are not amplified. This allows for multiplex amplification of a large number of target sequences, for example, 200 to more than 20,000 selected target sequences from a complex sample such as a genome. The length of each target may be, for example, about 100 to 1000, about 200 to 1000, about 200 to 500, about 200-2000 or about 100 to 5,000 bases. In one embodiment the ends of the targets may be defined by restriction sites in the genomic DNA sequence.

The template probes may also be used to mark the targets with one or more additional sequences. In a particularly preferred embodiment each template probe has a unique barcode sequence between one of the priming sequences and the target complementary region. The target is hybridized to the template probe and oligonucleotides that are complementary to the tags and to the common priming sequences are added and allowed to hybridize to the template. The pieces are hybridized to the template probe so that the ends are juxtaposed and can be ligated to form a contiguous sequence. In some aspects template probes have more than one barcode sequence. The barcode sequence can be used as a unique identifier of subsequent products.

The template probes are synthesized so that the target complementary region has defined ends. The genomic DNA sample from which targets are to be amplified is treated so that the targets have defined ends that correspond to the template probes. This can be accomplished in a variety of ways, for example, the ends may be generated by restriction enzyme digestion or by PCR.

TACL has been used to amplify up to 10,000 amplicons encompassing ˜1.6 Mb of DNA. In this procedure, 10,000 dUPs are used to capture the relevant sequences as described above. The capture is very specific. When DNA such as herring sperm DNA is used instead of human, no amplification products is obtained. This is indicative of very low intrinsic probe and other background, since protocols that involve amplification usually amplify some material even in the absence of proper targets. Due to this high specificity a small amount of input DNA can be used and amplified. In preferred aspects about 150 ng per reaction is used, but 30 ng and even 3 ng of DNA has also been successfully used.

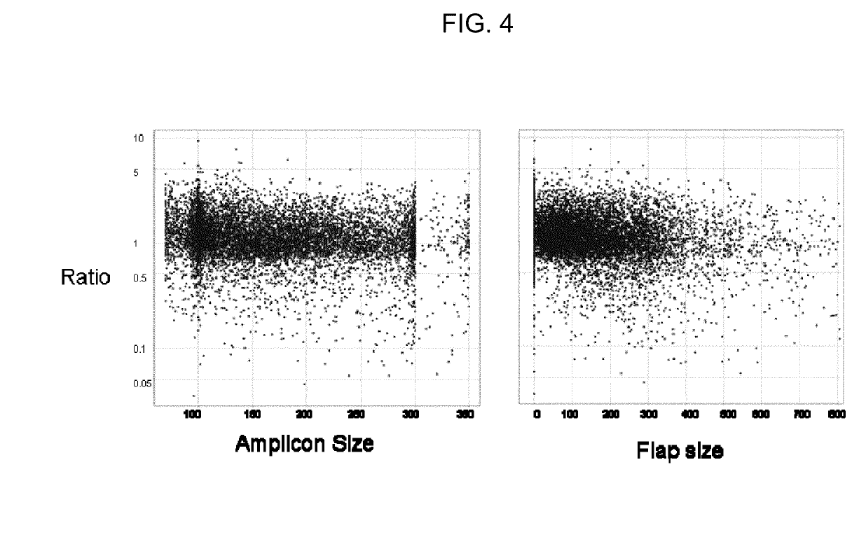

FIG. 4 shows the ratio of TACL product and the equimolar dUPs, indicating how well target DNA is captured. The amplification success does not have substantial dependence on the sizes of the amplicons or the flap. There are 15% of the amplicons with flap size of zero. The average drop in signal (reflected by drop in the signal ratio between the TACL product and the equimolar dUPs) between these amplicons and those with the largest flaps (800-1000 bp) is less than 30%. The drop in signal between the lowest and highest amplicon sizes is even less. The measured abundance may underestimate the real difference as signals on the array can reduce the true difference.

TACL differs from other capture methods by several important aspects. For example, TACL has the following advantages. (1) TACL utilizes solution hybridization which is more efficient than solid phase hybridization. This contributes to the excellent sensitivity of TACL, allowing for the use of small amounts of DNA. (2) The ligation step and UDG elimination of probes makes TACL very specific for amplifying only the targeted regions. Since the background of probe amplification is almost non-existent more cycles of amplification can be performed contributing to the excellent sensitivity of TACL. (3) Since the targets have specific ends, regions around the sequences of interest are not amplified. Although, the use of restriction enzymes can be restrictive for the design and some sequences may not be covered, this can be ameliorated through the use of multiple enzymes, for example three enzymes allows for coverage of 99% of sequences by at least one of the enzymes.

Both panels of FIG. 4 share the same Y axis depicting the ratio (in log scale) of the signal obtained after TACL compared to the signal from the dUPs. Ideally, this should be 1 for all amplicons. Most amplicons in the data set shown are not far from that. On the left panel the X axis shows the amplicon size. Most of the amplicons are below 300 with a small fraction in the 300-350 range. The right panel shows flap size.

In some aspects alleles are enriched using MRD. MRD is described in Faham et al. PNAS102(41):14717-22 (2005) and Fakhrai-Rad et al., Genome Res. 14:1404-12 (2004) and also in U.S. Pat. No. 7,153,652. The allele enrichment by MRD relies on hybridization of the test sequences with cloned references, or standards. These standards are generated once and are utilized with every test sample. The same pool of 1,000 individual PCR products that is used in making the dUPs is also used to make these standards. This pool is digested with two rare restriction enzymes to eliminate the common primers on both sides and generate cohesive ends. Then, the digested PCR products are ligated to a specific plasmid vector and transformed to a standard cloning E. coli strain. The plasmid prep that is then done serves as an eternal reservoir of the standard plasmids. The prepared plasmids is transformed into a dam⁻ E. coli strain to generate amounts of standard DNA devoid of dam methylation as required by the assay. It is important that only one allele is present in the standard. Therefore for the individual PCR, hydatidiform mole that is homozygous across all its genome is used. It is also preferable that the standard contains the common allele in the population, and hence for amplicons with a HapMap SNP, an individual homozygous for the common allele is used as a template for the amplification.

Making the standards uses the same labor intensive step of individual PCR as used for making the dUPs. The following steps (PCR with U for the dUPs and ligation and two transformations for the standards) are done en masse for >1,000 plex. dUPs and the standards are made once and then are used with every sample that is studied making the investment in the generation of these reagents reasonable when many hundreds or thousands of samples are to be studied. Methods for performing this amplification without using individual PCRs are described below.

In preferred aspects the standards are hybridized to the test PCR products and vector sequences with no insert. In one aspect, the methods may be used to analyze the exons of 1,500 genes. More than 10,000 amplicons covering >1.6 Mb may be hybridized in each of the three panels that cover the genes (one per restriction enzyme used in TACL). The hybridization forms a heteroduplex molecule with two nicks that are closed by a thermostable ligase. This heteroduplex is transformed en masse into a bacterial E. coli strain that is engineered to sense the presence of a mismatch. In the presence of a mismatch the bacterium grows in one medium and in its absence it grows in another. Plasmids from the variant pool (VP) and non-variant pool (NVP) are prepared and the inserts amplified through the use of common primers. The content of these inserts are analyzed by hybridization on arrays.

In previous reports the resulting pools were hybridized onto a generic barcode array to assess the fragment content of the two pools. This identifies the fragment with a variant but does not determine the exact sequence change. As disclosed herein a modified resequencing array instead of a barcode array may be used to obtain the sequence change at the step of the array hybridization. The analysis to obtain high quality resequencing data is described in more detail below.

Bacterial cloning is often criticized as inefficient. Inefficiency on this process is due to the usual colony picking and processing steps as well as the inefficient intermolecular ligation. The methods disclosed herein largely avoid both problematic steps. No individual colony need be processed in the standard making or the MRD assay, but cultures of bacteria carrying many inserts may be used. Whereas making the standards requires an intermolecular ligation reaction, in the MRD assay the hybridization event forms the appropriate molecule requiring only the more efficient intramolecular nick closure to generate the heteroduplex molecule. The ligation for making the standards can be less efficient as it is done only once. In order to compensate for that it may be preferable in the standard-making procedure to process no more than 1,000 amplicons simultaneously.

E. coli detects single base mismatches and small deletions 1-3 bp in length. To evaluate whether the enrichment worked on all classes of single base variants the following assay was performed. There are 4 different types of single base variants as defined by the types of mismatches combination they produce. The single base changes are A to or from G (C to or from T), A to or from C (G to or from T), A to or from T, and G to or from C. These are referred to as A/G, A/C, A/T, and G/C, respectively. A/G is the predominant type among SNPs accounting for ˜70% of all SNPs. A/C accounts for ˜15%, with A/T and G/C covering the remaining 15% of all SNPs.

Data from HapMap samples with known variations was used. It may be useful to manually inspect known SNPs, one at a time, to see whether the enrichment worked or not by looking at the relative signal in the VP and NVP. Some variants had low signals and/or had diffuse clusters and were not detected, but this is not likely to be a problem of the enrichment but rather other aspects of the technology (e.g. amplification. etc). No enrichment problem was observed in any of the A/G, A/T, and G/C variants. However a fraction of the A/C variants did have an enrichment problem. Increasing the MutS, the mismatch-binding protein, in the cell may result in better detection of A/C alleles that are not enriched robustly. The strain has been modified to overexpress MutS. Indeed the new strain maintained the enrichment of SNPs detected in the standard strain, but also now was able to consistently and robustly enrich those A/C SNPs that were not previously missed

Features of MRD include the following. The whole procedure including the transformation is done in a 96 well format. The process is robust and scalable. In one transformation with a heteroduplex preparation, one can obtain 100 million transformants carrying ˜16 Gb of insert sequences allowing high redundancy while studying many millions of bases. In the VP, the variant allele is enriched to near homozygosity facilitating detection in later steps. In addition to the VP where the variant allele is determined, the MRD procedure generates a NVP that can lead to improved data quality as discussed below.

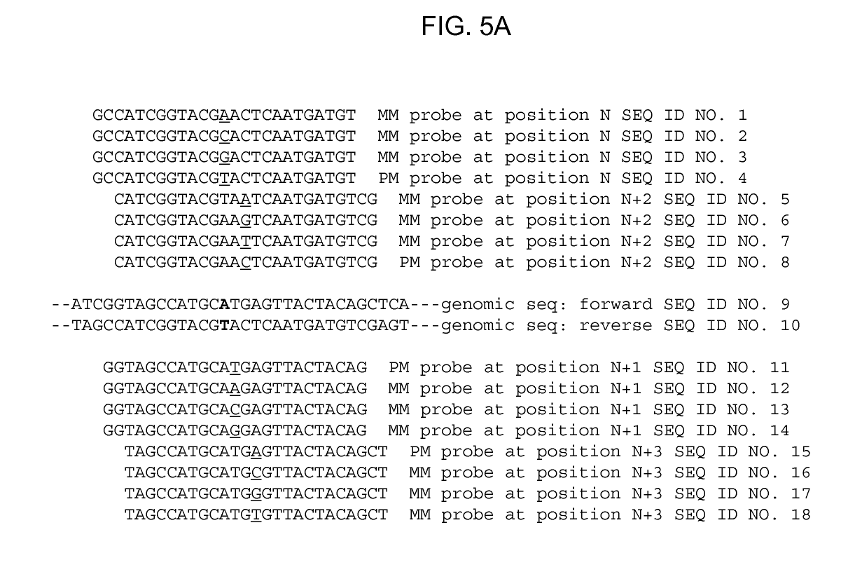

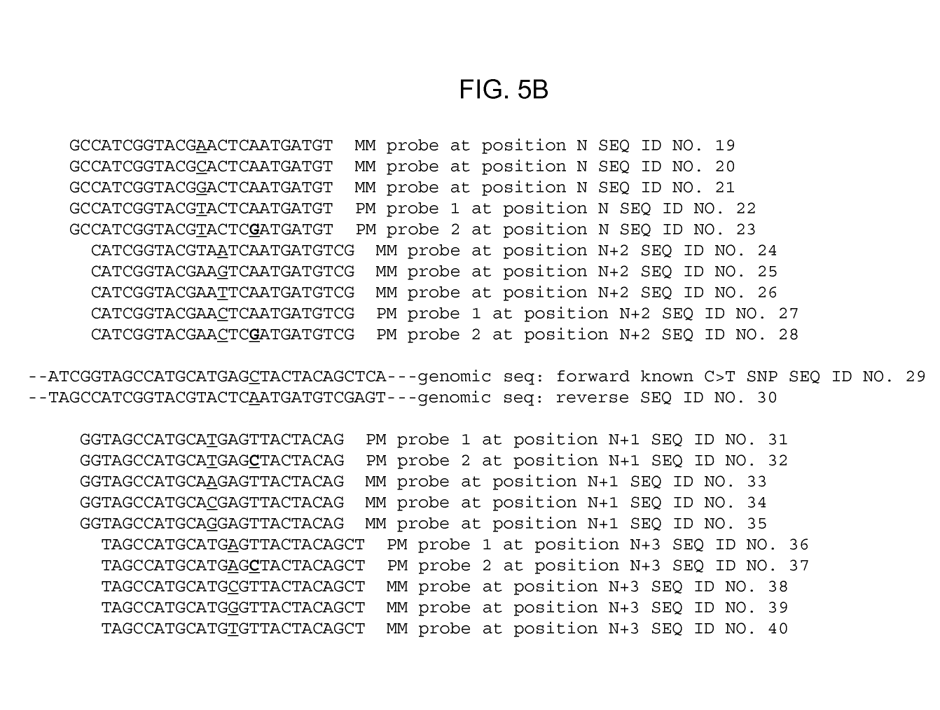

In preferred embodiments array based sequencing is used. FIG. 5 shows tiling strategies of one embodiment of the presently disclosed methods. In 5A a region without known SNPs is tiled. The array contains four probes per base being interrogated; one perfect match (PM) probe that matches the reference sequence and three mismatch (MM) probes in which the center base differs from the reference sequence. Adjacent bases are alternately interrogated with probes matching the forward or reverse strands. Probes to interrogate four positions (N, N+1, N+2, N+3) are shown. FIG. 5B shows tiling in a region with a known SNP, each base being interrogated has two PM probes as well as the three MM probes, one that matches each allele of the SNP. The MM probes have the reference allele at the SNP.

In this embodiment, there are ˜1.65 M “perfect match” (PM) probes that match the reference sequence. Each base in each amplicon appears in the middle position (13^{th}) of one PM probe. Note that each reference base also appears once in each other position in a probe (1^{st}, 2^{nd}, 25^{th}) which is an important feature of the calling procedure discussed below. For each PM probe, there are three additional “mismatch” (MM) probes (4.95M total probes of this type), identical to the PM probe except that each of the other three bases appears in the middle position. So, if the PM probe has C in the middle position, then the other probes (otherwise identical) have A, G and T in the middle.

The probes are complementary to only one of the strands, and the strand switches at every position. Therefore on each strand every other position is present on the array. Correlation of signals from probes in different strands correlate less than neighboring probes on the same strand, and therefore the switching provides more information than using one strand alone. The standard resequencing array uses both strands for each of the features, and hence the design described herein reduces the number of probes required to study a specific sequence by half.

Finally, in order to obtain more information in regions nearby known SNPs, in preferred embodiments the arrays include extra tiling in these regions. For each PM probe, if there is any known SNP in dbSNP within the 25-mer, then there is one additional probe for each PM. It is identical to the PM except that at the SNP position, the base is the other SNP allele than the one on the reference sequence. The use of these probes is discussed below.

In preferred aspects novel methods of data analysis and management are also contemplated. In particular, it is desirable to maintain very low false positive rate in resequencing studies. In preferred aspects this may be achieved through an algorithm that depends on three layers of analysis: ratio, dip and base analysis as described below.

Ratio analysis is an analysis on the whole amplicon scale focused on asking whether a fragment contains a variation or not. When an amplicon contains a variation, it is sorted into the VP (variant pool), and hence the “ratio” of the fragment in the VP to that in the NVP (non-variant pool) is greatly increased relative to other samples with no variation. In this analysis, only the PM features are considered. For an amplicon whose size is X bp, there are X PM features that correspond to it. At a minimum X is 70 and on average X is 160. Therefore on average this measurement results from 160 features on average, and hence is rather robust. It is of note that in preferred aspects this analysis uses data from the VP and NVP from each sample. The other layers of analysis do not require data from every NVP and focuses on the VP. The use of the NVP data allows for distinguishing heterozygous from homozygous variant calls as the former are present in the NVP.

The contrast between the variant and non-variant signals can be plotted using the X axis to show contrast and the Y axis to show the sum of the signal. The contrast may be computed as (Vs−NVs)/(Vs+NVs). If the fragment is NV, variant, or heterozygous, the contrast is expected to be −1, +1, or 0, respectively. The Y axis may be the signal sum (Vs+NVs). The distance on the contrast axis for a sample from the non-variant cluster is the essential element of the ratio analysis. It is of note that for each amplicon Vs and NVs are computed as the median signal among all the PM features.

Dip analysis may be used as a second layer of analysis. Variants that were heterozygous in the subject's genomic DNA are enriched in the variant pool to near homozygosity. Therefore variant sequences exhibit markedly reduced hybridization to the PM probes. This reduction occurs for the PM probes for the bases 10 bp on each side of the variant (i.e., for probes with the variant base at positions ˜3-23) with the most dramatic reduction when the variant is close to the middle position. In most cases this “dip” localizes the variant to +/−3 bp, but some variants can be as far as +/−8 bp from the “dip”.

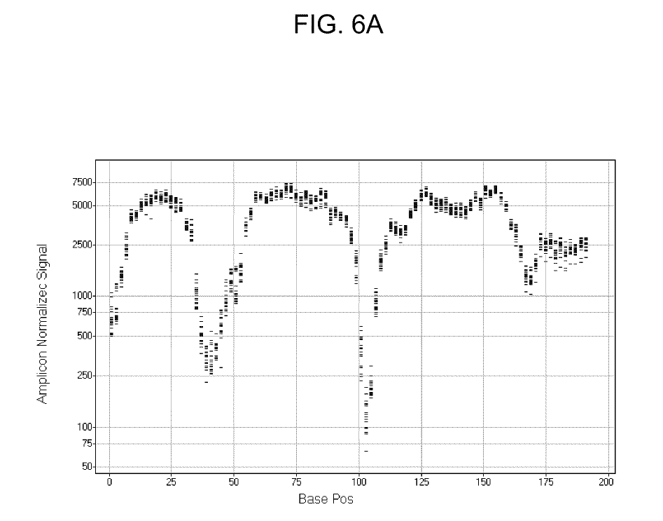

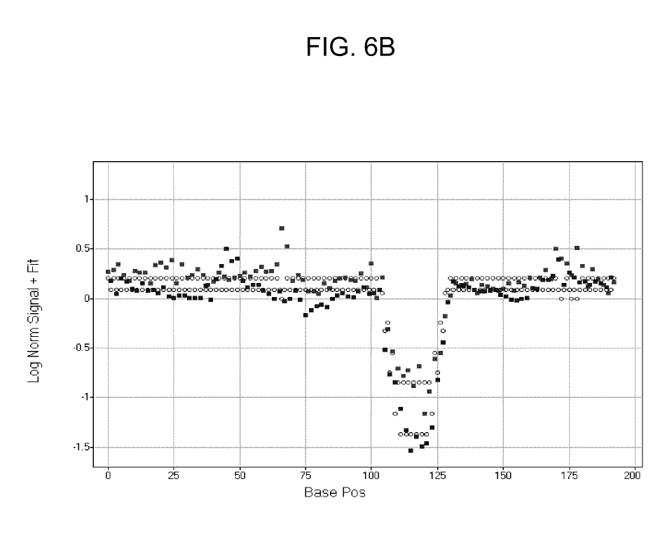

Like the ratio this analysis uses only the PM features. But unlike the ratio analysis, the dip is mainly focused on the VP. Only a small number (˜20) of NVP are analyzed and these serve as a reference to normalize the signal from different probes as shown in FIG. 6.

The dip analysis does not identify the exact sequence change, but localizes the variant to a small segment. Since the dip in signal is measured over multiple features (15-20), it is reasonably robust. In order to determine the exact nature of the change, a third layer of analysis may be performed.

In FIG. 6A the X axis shows the base position for a specific amplicon. The Y axis shows the signal obtained for each position from 19 different samples. Even though the signal differs drastically among positions, the signal for each position among different samples is relatively tight. Therefore one can use the data from some NVP to build a model of the expected signals for each position. Data from the variant pool is then compared to the model and the presence or absence of a dip is then determined. In FIG. 6B the X axis is the same as in 6A. The Y axis shows the data from the VP of the two strands in solid squares as well as the fit for the dip model (open circles). A dip representing a reduction in signal around the site of a variant is apparent.

In base analysis the analysis is directed at identifying the exact sequence change within the dip. In a preferred embodiment the probes that are +/−8 from the center of the dip are considered. Within this segment there are 51 possible variants each of which relates to a specific MM probe.

For each MM probe, a contrast value (MM−PM)/(PM+MM) is computed. The variant allele causes the most increase (relative to samples with no variants) in the contrast value that corresponds to the MM probe that can favorably hybridize to the variant. The presence of the variant allele at near homozygosity facilitates its detection. In preferred aspects a calling algorithm is used that combines the above three analyses. For each analysis, a score is given for each amplicon in every sample. A combined score is then generated from all three scores, and then a threshold is set above which data points are called variants and below which the data points are called non-variants.

When more than one variant is present in the same sample for the same amplicon, a modification of the algorithm may be used. The simple modification is that after identification of the first variant, one can look for another variant using the second and third analysis layers (dip and base) but not the ratio because the ratio pertains to the amplicon as a whole and is thus already affected by the first variant. In this case only the dip and base analyses are combined into a single score for calling these variants. In preferred aspects the search for more than one variant in the same sample and amplicon is limited to those cases where one of the variants corresponds to a variation at a SNP already known in dbSNP or other SNP database.

In addition to the above three layers of analysis an additional analysis may be done for known SNPs. In one aspect the array includes extra features for all the SNPs in dbSNP for a given amplicon. Each of the two alleles of all SNPs are tiled in all 25 positions with respect to location of the SNP within the probe sequence. In preferred aspects the 15 probes where the SNP is less than 8 bases from the probe center are used to do the SNP analysis. The status of the allele can be surmised through the median (from 15 probes) contrast between the two alleles in the variant pool of the specific sample compared with the contrast of all the sample that are determined from the ratio to be non-variant. This SNP analysis may be done for all known SNPs in an amplicon. In those samples with identified variant alleles in the known SNPs, a search may be done for any other variants at all other potential sites in the same amplicon.

In general the steps of the analysis are: Do SNP analysis on all the known SNPs. This will find variants that occur at known SNPs. Based on this result use one of two strategies to find variants that occur at unknown SNPs: Triple Combo Analysis: Combine the ratio, dip, and base analyses together for all cases where a sample has no variant alleles in the known SNPs (for the given amplicon). This represents ˜94% of all the variants that occur at unknown SNPs, since in most cases there is no variation present at the known SNPs for each amplicon. Double Combo Analysis: For those cases where a sample has one (or more) variations in the known SNPs of the given amplicon (based on the SNP analysis), do a double combo analysis (dip and base only) to search for additional variants at other sites than the known SNP(s). This only represents ˜6% of the variants that occur at unknown SNPs, since in most cases there is no variation present at the known SNPs for each amplicon

In order to calibrate the efficiency of the above variant detection pipeline three separate kinds of calibration analyses can be performed. First, SNP Calibration: Use known genotypes of HapMap SNPs to determine the sensitivity and false positive rate of the SNP analysis. Second, Triple Combo Calibration: this analysis may be restricted to amplicons with at most one known (HapMap) SNP in the entire amplicon. Wherever HapMap indicates the sample is variant at the SNP the triple combo analysis (ratio, dip, and base) may be performed. This effectively determines the sensitivity for detecting a new variant which is not in the presence of a variant at a known SNP for the given amplicon and sample, i.e. as in 2a) of the variant detection pipeline above. The false positive rate is determined by using amplicons that have been Sanger sequenced to find samples where there are no variants across the entire amplicon. These ‘Non-Variant’ cases are then subjected to the triple combo analysis (ratio, dip, and base). Since no variants are expected from the Sanger sequencing, any detected variants are false positives. Third, Double Combo Calibration: For finding new variants in the presence of variants at known SNPs (for the given amplicon & sample), i.e. as in 2b) of the variant detection pipeline above, it is preferred to use a different approach to calibrate the efficiency of detecting the second (new) variant. In this case amplicons were used that had exactly 2 HapMap SNPs and no other known SNPs. Cases where HapMap indicates the sample is variant at both SNPs were considered. Then perform, at both SNPs, a double combo analysis (dip and base only) which ignores the SNP analysis and the ratio analysis. This allows calibration of the sensitivity for finding the second variant since the same information (dip & base) as in 2b) of the variant detection pipeline is being used. The false positive rate is determined by using the same Sanger sequenced Non-Variant data as in Triple Combo Calibration (just above) but instead applying the double combo analysis (dip and base only) to find any false variants.

At first glance it might seem problematic to use known (HapMap) SNPs to calibrate the sensitivity for detecting variants at unknown SNPs. However, in both the triple and double combo analyses, no information from the SNP analysis or any of the SNP specific probes is being used. In addition, all of the metrics used in the ratio, dip and base analyses are explicitly chosen so that they do not depend on the frequency of the variation within the sample population. This ensures that the sensitivity does not depend on allele frequency, which would otherwise create a bias since known SNPs are of generally higher allele frequency than unknown SNPs. Nonetheless, it is a fair criticism to suggest that HapMap SNPs have some level of selection bias in that they have been found to perform well on at least one genotyping platform. Given the similarity of different genotyping platforms, detection of these is potentially ‘easier’ than to detect than ‘average’ SNPs. The effect is expected to be small, particularly that the allele enrichment is unlikely to be well correlated with ability to genotype on other platforms.

In addition to quality control (QC) steps in the laboratory, the array results routinely generate QC metrics on a per sample basis. These metrics are focused on the various steps. Low signal to background usually indicates some problem with the array hybridization. That combined with the signals from the control oligos can be used to determine whether the problem was in the hybridization or the test sample. Another recorded metric is Ln (PM-MM) which is averaged across the whole array and again can be indicative of array hybridization/washing that was not properly performed. A metric to follow the transformation step is the non-variant standard deviation which measures how tight are the non-variant calls in a sample. Samples with too few transformants usually have high non-variant standard deviation. Finally, call rate is another functional metric. A low call rate due to low signal in amplicons but average signal in the array overall can indicate a problem in the TACL where only a fraction of the amplicons are amplified

To test the methods, ˜5 Mb of DNA was resequenced from each of 704 genomic samples. The 5 Mb represent exons of ˜1,500 genes that were chosen based on their potential role in cancer. All the exons as well as 10 bp of the surrounding introns were targeted. The targets were covered in at least one of three pools—each with a specific restriction enzyme at the TACL step. Each pool has slightly more than 10,000 amplicons. Overall there was ˜5% of the bases were covered in more than one pool.

The experiment was done in 96 well format for all the steps (except the array), and every sample went through TACL, MRD, resequencing array, and the automated calling algorithm. The procedure starts with genomic DNA digestion, hybridization to dUPs, flap endonuclease and ligase treatments to link common primers to the captured genomic fragments. A UDG treatment eliminates the dUP, and this is followed by PCR amplification with common primers to amplify the captured fragments. The MRD steps starts with purification and restriction digestion of the TACL product to eliminate the common primers. This is followed by hybridization to the standards and ligation reaction to form the heteroduplex. Exonuclease treatment then eliminates the molecules that are not closed circles. Salt is eliminated through a purification column, and the mixture is then transformed into bacteria. The culture is split in two culture representing VP and NVP. These are minipreped and are subjected to PCR with common primers to amplify the fragments. These amplicons are then fragmented, labeled, hybridized on the array that is later washed and scanned.

In this example, the analysis was limited to 84% of the amplicons that generated high quality data. Important metrics for evaluating a re-sequencing technology is the false positive and negatives. In order to determine that data representing true positives and true negatives may be used. The true positives were easily available through the HapMap. Among the 704 studied samples, there were 24 HapMap samples. Known variants from the HapMap study represented true positives allowing us to compute the false negative rate of the technology. The true negatives were harder to obtain since SNPs not assessed by the HapMap may be present in the studied samples. Traditional Sanger sequencing was performed followed by extensive manual review to obtain a “true” negative data for ˜750,000 bp. Analysis of the ROC curve representing the false positive/false negative trade off shows that ˜88% sensitivity can be obtained at false positive rate of ˜ 1/250,000 bp. ˜95% of the variants are called at the base level while the remaining 5% are called to be a variant but the specific variant base was left undefined. As noted above even though there are extra features corresponding to the SNP sites, they are not used in this analysis and hence this performance should be the same as for previously unknown variants. In addition there is nothing in the algorithm where there would be an advantage to detect higher frequency alleles than lower frequency alleles. For example clustering on the variants is not performed. In that case the more variant calls present the easier it is to detect the cluster. Instead for all ratio, dip, and base, we define a non-variant cluster and then consider for each sample how far from that cluster it is and give a score. Therefore even though the known SNP tend to be more common the performance described above should be the same for the rare alleles that tend to be previously unknown.

Consistent with this false positive measure, the rate of discordant bases observed in repeat experiments or in Mendelian errors in trios is less than 1/400,000 bp. Further performance improvement in conversion (proportion of amplicons analyzed) and false positive/negative trade is possible.

High quality resequencing data for ˜5 Mb of DNA accounting for a little less than 10% of the exonic sequences has been demonstrated. The methods disclosed herein should allow 10× scaling up from this level while maintaining or improving the accuracy. It should also be possible to increase the throughput of resequencing from one array by 6 fold going from the current 1.65 Mb to more than 10 Mb. Using 6 arrays, 60 Mb (2%) containing all the protein-coding exons as well as some other important regions like miRNA can be assayed. The methods should also allow for an increase in the throughput by more than 10 fold to more than 18 Mb, allowing the coverage of 54 Mb in 3 arrays and containing the protein-coding exons.

In many aspects the following three metrics of performance are used: conversion, false positives, and false negatives. These metrics can be improved by making minor changes that include modifications to the following factors: optimization of the heteroduplex formation, algorithm refinement, for example, by using more true negative data, and better analysis for amplicons with SNPs.

Optimization of heteroduplex formation can be achieved as follows. In the experiments described above, the false positive/negative trade off was calculated on only 84% of the “converted” amplicons. Of the 16% of markers that were not converted ˜60% have low signal. Material was taken from the various steps in the process and hybridized on arrays to understand where the “loss” happened. There was very high correlation obtained between the signal obtained from the heteroduplex and that after transformation, indicating there was no loss in this bacterial transformation step. Loss was observed in the PCR reaction that leads to the panel making, in making the standards, in the TACL, and in the heteroduplex formation. The highest two categories were the initial PCR and the heteroduplex formation, with each losing 3-4% of the total amplicons. The ones lost in the initial PCR represent sequences that are difficult to amplify and it is not straight forward to recover them. Amplicons lost in heteroduplex formation are present in the TACL and the standards but fail to form a heteroduplex. This was somewhat surprising as this step was set to narrow the range of the products from the TACL product by using this product in a 10 fold excess to the standard amount. The sequences lost tended to be highly AT rich sequences. These may be denatured in the PCR purification step (after TACL) before the restriction digest step that is done to eliminate the common primers before the addition to the standards to form the heteroduplex. The single stranded nature would not allow the restriction digestion to work and hence lead to the amplicon disappearance from the heteroduplex.

By doing the purification in conditions that would not allow the denaturation to occur this class of non-converted amplicons may be recovered. These amplicons that are totally lost in the heteroduplex step are the extreme of a distribution of amplicons whose concentration is decreased in this step. Hence ameliorating the loss at this step may shrink the range that various amplicons are present in the heteroduplex (and ultimately in the culture and array). The smaller range would likely improve the data quality as the lower representation amplicons get higher number of transformants and their detection on the array does not lead to saturation among the high signal ones.

Algorithm refinement by using more true negative data. As mentioned above, ˜40% of the markers that were not converted had sufficient signal. These markers may have diffuse and ill-defined non-variant cluster, the cluster is shifted from its usual position, or the vast majority of samples were variant—indicative of a rare variant in the standard. Manual inspection of this latter class clearly suggests that many of these markers are “recoverable” through changes in the algorithm to allow the detection of the shifted clusters. Similarly of the markers with low signals there is probably a fraction that is also “recoverable”. For keeping the false positive rate down, a relatively conservative signal threshold may be enforced. The risk in doing these changes (whether to recover the high or low signal markers) is the increase in false positive rate. Studies typically do not have a sufficient amount of true negative data in these types of markers to distinguish the safe changes from those that would create a false positive problem.

In the analysis described above there was adequate true positive data through capitalizing on more than 30,000 true positive calls from the HapMap database. False positives can be identified by Sanger sequencing. Those that do not validate by Sanger may be considered false positives, and those that do validate may be discarded. The true positives that validate may be discarded so that they do not inflate the sensitivity. All the non-variant calls can be considered true negatives. This would increase the true negative data by ˜100 fold. It is of note that some of those that would be considered true negatives would indeed be positive. However given the small number of positives and the yet smaller number that are missed, these true positive will increase the denominator for the false positive calculation by less than 1% and would not therefore represent any meaningful bias.

Obtaining more true negative data allows the algorithm refinement that enables the recovery of some of the markers. It is expected that the proportion of converted amplicons should increase to >90% through these algorithmic and lab changed discussed herein. In addition, more true negative data can have a profound effect on the false positive/negative rate. Currently only 3 false positives are obtained in three arrays combined. Therefore the number of true negatives is limiting to the establishment of exactly what the level of false positive is as well as understanding the source of these false calls for further improvement. Obtaining 100 fold more true negative data would enable the refinement of the algorithm to improve the false positive/negatives trade of.

The presence of two SNPs in the same amplicon presents extra challenges to the analysis. In general we found in the study of exons from 1,500 genes that ˜6% of amplicons in any individual have a variation. The majority (˜90%) of identified SNPs were already in dbSNP. Therefore ˜6% of rare variants are expected to occur in the context of another variant, and in 90% of these cases the other variant is in dbSNP. These are relatively uncommon situations and hence potential algorithmic improvements would only yield limited advantage when overall sensitivity is considered. The complication of two SNPs in the same amplicon presents platform specific challenges. It is expected that the analysis can be improved to achieve better sensitivity for those cases where there are two variants at least one of which is in dbSNP. We can also consider implementation to look for multiple SNPs none of which is in dbSNP, but that is likely to be rare.

As discussed above the current algorithm consider the extra features related to the SNP to determine whether the SNP is present in the specific sample. If it is present a search for an additional dip (and base) is performed. When there are two variants in the same amplicon then they may be on the same chromosome or on opposites ones. Our current algorithm is appropriate for the former case that should constitute ˜half the cases. In the other half of cases where the two variations are on opposite chromosomes then the ratio analysis is expected to identify that both chromosomes are variant (no signal from the NVP. However it would not be clear from the ratio analysis whether the two chromosomes are variant for one SNP or two distinct SNPs. If there are two distinct SNPs on opposite chromosomes, then in fact neither would be enriched since both would be present in the VP. That will be reflected in a smaller dip. Using the extra features for known SNPs this would also be apparent in the median (among the 25 tiles) SNP contrast between the two alleles. Therefore the hallmark of the scenario of two SNPs on opposite chromosomes is that one obtains strong ratio signal (very little NVP signal), but lower than expected dip and SNP contrast at the known SNP site. When this hallmark is seen we can ask the algorithm to look at another variant at lower threshold since we would be reasonable certain of the presence of the other variant.

This modification should allow the detection of the majority of SNPs that are in the same amplicon of another known dbSNP in heterozygous form. Finally there is the case where a homozygous variant dbSNP is present in the same amplicon as an unknown variant. This would not fit the hallmark mentioned above of lower dip and SNP contrast signal at the known SNP site since it requires no enrichment to become homozygous. Therefore this is the more complicated case since the dip and base expected from the unknown SNP are likely to be weak, and the absence of the hallmark mentioned above makes one uncertain whether there is another SNP or not and hence reduction of the threshold of calling may create false positive. It needs to be evaluated whether reducing the threshold slightly in these cases to obtain more sensitivity while increasing the false positive rate is worthwhile or not. This can be tested when more true negative data is available through ROC analysis.

Conveniently, the case of homozygous variant in a dbSNP is only a small fraction of the 6% of amplicons with a variant. This case can be minimized by attempting to make the standard have the major allele. This may be accomplished by running the initial panel on a set of samples and looking for amplicons where the standard has the minor allele. In those cases the standard may be remade using as template for the PCR reaction an individual homozygous for the major allele. Typically this needs to be done in only a small fraction of cases (slightly more than 1% of amplicons), and for the majority of cases those amplicons have HapMap SNPs. Any chromosome is likely to have the major allele and the rarer an allele is the more likely a chromosome is to have the major allele. Since the HapMap is biased to have more common alleles, it seems reasonable that most cases where the standard has the minor allele it would be a HapMap SNP.

It is likely unnecessary to take additional steps to minimize the cases where an amplicon has the minor allele. A much lower effort that still achieves most of the value is simply to use the HapMap data and pick samples that would have homozygous major allele. Since being homozygous for the major allele is common, using 6 samples essentially any marker (˜99% markers that have a minor allele frequency of <30%) will be homozygous for the major allele in at least one of them. So for ˜90% of amplicons with no HapMap SNPs the homozygous hydatidiform mole may be used as a template for PCR to make the standard, and for the ˜10% of amplicons with HapMap SNPs the appropriate one of six HapMap samples may be used as a template for the PCR.

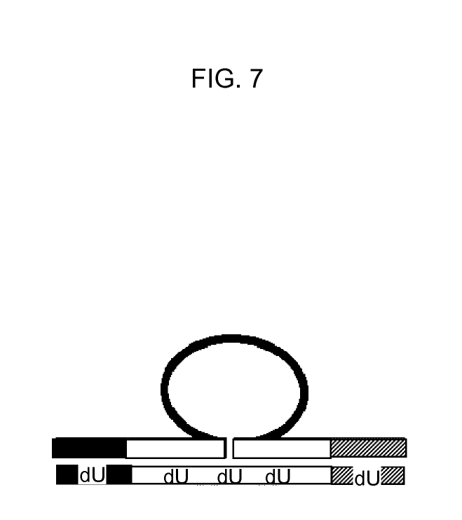

Although, the panel (dUPs and standards) may be made using PCR reactions using individual oligos this is a resource intensive step. Since it need be performed only once as the constructed panel can be used repeatedly it is a workable solution, but other methods may also be used to generate the standards and dUPs. In one embodiment, pooled oligos synthesized on arrays and then cleaved from them can be used. Each oligo has common regions flanking the unique targeting region in the middle. No individual PCR amplification is required to create the dUP, as it can be chemically synthesized. A synthesized probe need not cover the whole amplicon as amplicons can be as large as 350 bp and the synthesized oligos are preferably at most 200 bp. Instead, the two sides of the fragment can be synthesized. The genomic target would hybridize to the two arms of the dUP and have a loop in the middle (FIG. 7). This maintains the high specificity of the technology by requiring the two ligation events at both ends to attach the common primers. This strategy ensures that even though only part of the sequence is synthesized chemically, the TACL product contains all the desired target sequence.

To generate the dUPs one can simply amplify the oligo pool with common primers using dUTP instead of dTTP in the PCR reaction. The resulting double stranded product may be used as dUPs. To determine the feasibility of using oligo pools, two main things were measured. First, that there was a tolerable dynamic range of synthesis among the different sequences. Second, that the presence of the loop did not create problems. FIG. 7 shows a method for target capture using a loop. The lower strand is the dUP that is made from the chemically synthesized oligo pool. The upper strand has the two common primer as well as the captured genomic target. A loop is formed as the captured target is longer than the dUP. Ligation on both ends to connect the common oligos to the captured sequence maintains the specificity.

To test this method, a pool of oligos was obtained. The pool contained 10,000 oligos corresponding to one of the three panels that had already been made through individual PCR reactions. The size of the oligos ranged from 110 (70 unique) to 200 (160 unique) nucleotides to capture genomic targets 70-350 in size. The pool was amplified using common primers, and the products were hybridized on arrays to assess the fraction of fragments that were present. The signals from the array were compared to the signals obtained from our previously constructed dUPs that were individually amplified and mixed at ˜equimolar ratio. The majority of the fragments (˜90%) were present, even though over larger dynamic range compared to the ˜equimolar dUPs.

A TACL reaction was performed to assess whether dUPs synthesized in this fashion can support the TACL reaction. The effect of the loop on the efficiency of TACL was evaluated by looking at the ratio of the signals from the TACL product compared to the dUPs made from pooled oligos. The ratio drops by 30% when the loop size goes from zero to ˜200 bp. Other confounding factors are present since the fragments with larger loops have also longer oligo synthesized and the overall amplicon is longer. Therefore the effect of the loop alone is probably less. On the other hand as noted previously the array signal can shrink the real difference. In the case of sequencing the shrinking of the dynamic range is actually an advantage as it enables large dynamic range amplicon abundance to be assayed on the same array.

In preferred aspects, the different dUPs are present at similar abundance. Since the different targets are present at uniform concentration in the genomic DNA, we hypothesize that the TACL reaction may be useful in making the dUPs at similar concentrations. For this we would use the initial dUPs made from the oligo pool in a TACL reaction. The TACL would be done under conditions that would drive the genomic capture to completion (high dUP amount and long hybridization time). The dUPs are used in huge excess and hence even sequences that are underrepresented in the dUPs are still used in vast excess to genomic DNA. If the capture is driven close to completion then the concentration of the different sequences in the TACL product would be more uniform. This normalized TACL product can then be used to make the standards by cloning into the appropriate vectors. The dUPs can be also made by a PCR reaction using U instead of T using as a template the normalized TACL product.

It has been demonstrated that TACL can be scaled from TACL 384-plex to more than 10,000-plex with little reduction in specificity. TACL has also been performed at 20,000 plex with no deterioration in specificity/sensitivity. It should be similarly possible to amplify 60,000 fragments to assess 10 Mb on one array. Given that there has been little deterioration in specificity over the scale up already performed (384 to 20,000 plex), it is anticipated that the 60,000 should be successful.

An important element in the MRD step is to obtain adequate coverage and redundancy at the transformation step. In fragments that have no variation, there is a small amount of background (2-3%) growth in the variant pool due to PCR error and other causes. The ratio analysis aims to uses the degree of growth in the VP and NVP. With ample numbers of transformants the background growth can be easily distinguished from the case where there is a real variant (˜50% growth). However, as the number of transformants decreases the random fluctuation in the proportion in the VP increases leading to deterioration in the separation between the non-variant and variant clusters.

In an example, 10-20M transformants were obtained per reaction. To achieve the six fold increase in the number of amplicons studied and hence to keep the same number of transformants per amplicon the total number of transformants will be increased to ˜100M. This can be achieved through the use of more cells and more heteroduplex. This amount of heteroduplex required would still be only half of what is routinely prepared in the current protocol.

Methods for increasing the sequencing throughput of one array by 6 fold from ˜1.65 Mb to 10 Mb through the use of enzymatic reactions on arrays with smaller features are also disclosed. In some aspects on-array enzymatic reactions may be used. In the arrays described in above, there are four features for every position. Alternatively one can obtain the same information content from one feature by using 4 color readout of an enzymatic reaction. Enzymatic reactions that may be used include extension of a probe, for example primer extension using a labeled base and ligation.

The use of ligases allows the use of arrays where the 5′ of the oligonucleotides are away from the array surface. This is the standard chemistry that Affymetrix has been commercializing. An additional feature that can be included is the addition of phosphate to the 5′ end of the probes of the array, making them ready for ligation. The process for this array modification is currently available. After hybridization, 4 pools of 9 mers are added. Each of the pools has a unique 3′ end base while the rest of the positions are random. A unique hapten is present on the 5′ end. Ligation is then done to covalently attach the terminal base of the array oligonucleotide to one of the 9 mers. The specific 9 mer that ligates has at its 3′ end the base that is complementary to the target. Later the target is removed and the array stained and scanned appropriately.

The genotyping assay involves hybridizing genomic DNA onto the arrays followed by hybridizing the 4 pools of 9 mers mentioned above and performing the ligation reaction. Table 1 shows the genotyping metrics that are obtained in such assay. In this experiment, 20,000 random HapMap SNPs are genotyped by hybridization of genomic DNA followed by the ligation with 4 pools of 9 mers, each with a specific base at its end. After elimination of 7% of the SNPs that provided poor data, the call rate and accuracy (compared to hapMap) of the homozygous (AA or BB) or heterozygous (AB) samples.

TABLE 1
Genotyping results using ligation.

| Hom | Hom | Hom | Hom | Het | | | |
|---|---|---|---|---|---|---|---|
| “AA” | “AA” | “BB” | “BB” | “AB” | Het “AB” | Overall | Overall |
| call rate | accuracy | call rate | accuracy | call rate | accuracy | call rate | accuracy |
| 99.29% | 99.86% | 99.19% | 99.86% | 97.63% | 99.42% | 98.81% | 99.75% |

The use of ligase reactions for sequencing allows increased efficiency because a single feature can be used for each position. The ratio analysis is unlikely to be affected by the use of ligase. However, the use of ligation may add extra information to the dip analysis. Signal obtained from the ligation reaction means that there was hybridization followed by ligation. Hence the dip that we have observed due to hybridization will remain. In addition, mismatches close to the terminal base are likely to inhibit ligation and hence the dip is likely to exist not only when the mismatch is close to the middle (due to reduction of hybridization) but also when the mismatch is close the 5′ end (due to ligation).

When optimizing, the effect on the base and dip analysis should be considered. For the base analysis, define the base signal to background in the following manner. When a 9mer with the A at the 3′ end is used then signal is what is observed in those probes that are supposed to ligate to it (the next base on the target is T), and the background is the signal that is observed in probes that should not ligate to it. For the dip analysis, we will use probes that have one mismatch at different distances from the terminal 5′ base. Then dip signal to background is then defined as the signal obtained from the perfect match probe to that of the mismatch. The dip signal to background can be computed as a function of distance from the terminal 5′ base.

Using these two metrics: base signal to background and dip signal to background (the latter can be measured at different distances from the 5′ terminus) the assay may be optimized. These metrics can be computed through the use of one array only and hence many conditions can be tested relatively readily. Optimization may include different temperatures, ligases, and ligation reaction conditions in order to maximize the base and dip signal to background.

All these factors can be optimized using the array that was used to generate the data in the preliminary results. On additional factor to optimize is the length of the array probes. In order to do that an array with probes that are 25, 30, 35, 40, 45, and 50 in length may be used. The assay may be optimized by following the base signal to background and dip signal to background.

In some aspects smaller feature sizes will be used for the arrays. The arrays that were used to generate data described above have 5μ distance from the center of one feature to the next. For these arrays the area with active probes is 3μ (×3μ) and the remaining 2μ serves as a buffer between features. Recently arrays that are 4μ center to center, with 3μ (×3μ) active probe area and the buffer reduced to 1μ have become available. The performance of these arrays approximates that of the standard 5μ arrays. The ability to go from 5μ to 4μ translates to an increase in the number of features from ˜6.8 M to over 10.6M. This 50% increase combined with the enzymatic use that provides 4 fold savings in the number of features would allow ˜6× increase in the sequencing throughput from ˜1.65 Mb to over 10 Mb

Feature size can be pushed further to become 3 micron center to center (resulting in over 18.8M features per array). These arrays are currently available. The success in the 3μ arrays would provide nearly a factor of two in cost saving.

The same array that has the different probe lengths may also have features of different sizes: 5, 4, and 3μ. One can compare base signal to background and dip signal to background for each feature size while optimizing the enzymatic step.

In the example studies, the array used for the NVP was the same as that for the VP pool. However, the analysis performed on all the NVP was the ratio analysis. This analysis is aimed at quantitating the amount of each fragment in the VP and NVP, and at least 70 features and on average 160 data points are used per amplicon. Since the quantitation does not require information on every base, a lower density of probes should suffice. For example, we can use 30 features per amplicon. In preferred aspects these probes are selected in such a way that they are located an equidistant manner from each other alternating strands with every probe to get the maximum diversity of probes.

This idea can be tested using the data obtained in the example studies. Using only data points other than the 30 PM for each amplicon, we can assess if there is any deterioration in the ratio data. This can be rigorously analyzed through ROC curve analysis.

A small number of NVP may be used to generate the profile of the signals in different amplicons. However this only requires ˜20 NVP samples and need not be done on every sample. It would still be useful to run ˜20 samples on the dense array to generate the signal profiles, but the rest of the samples can be processed on a lower resolution array.

For each probe there will be 4 signals associated with it, one relating to each base. In preferred embodiments, define the perfect base signal in analogy to PM probe as the signal from the probe's expected (reference) base. For each probe there will be one perfect base signal and 3 mismatched bases signals that relate to the signals from the bases other than the reference base. In preferred aspects the analytical framework consist of the same elements: ratio, dip, base, and when relevant SNP analysis. The ratio analysis would be fundamentally no different from the analysis we are performing already as that relates to the amount of the amplicon present. Instead of the median PM in the VP and NVP pools, the median of the perfect base signal will be computed.

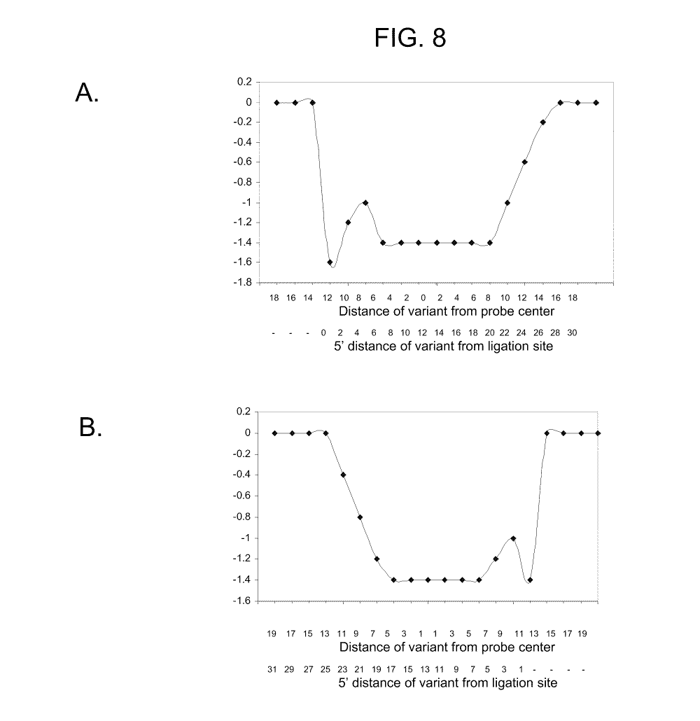

The dip is expected to be different from a solely hybridization-based method. If an oligo does not hybridize it would not be available for a ligation reaction. Therefore the dip that is currently observed is likely to persist. In hybridization a mismatch at the end of the probe causes little reduction in hybridization and hence the observed dips are only 15-20 bp in length and not 25 bp (the length of each probe and the number of probes any base is present in). However, when the mutant base is close to the 5′ of the probe then this is likely to cause some disruption to the ligation (FIG. 8). This disruption is probably maximal when the mismatch is at the terminal 5′ of the probe. The next base will then have no disruption of ligation, and the variant base is read. Therefore the dip is likely to be larger than we have observed previously, and it would have a sharp end defining exactly where the mutant base is expected to be. It is of note that this extension of the dip is in different directions for the two strands.

If a probe size larger than 25mer is used the effect of a single base mismatch on hybridization is likely to be lower. Therefore it is important at the optimization steps to consider the effect on the base and that of the dip as we proposed to follow base signal to background and dip signal to background. So if a probe length longer than 25mer is used that would be because the differential base advantage more than outweighs the differential dip disadvantage. Therefore in overall performance we do not expect to have worse performance than we have currently provided that the enzymatic base detection is no worse than hybridization.

The base analysis is likely to benefit from the more refined localization discussed above. Since less bases need to be considered a lower threshold can be used for calling leading to more sensitivity and/or lower false positive rate. In the current algorithm we only consider the base analysis in the dip region. If the use of ligation improve the quality of the data sufficiently then we could consider a somewhat different algorithmic structure: looking for the base across the full amplicon and then obtain the dip score in the position where the base was found. We would still combine all three scores to obtain a combo score and a variant is called if the combo score is above a specific value. We would consider both analysis frameworks: the process of looking for a dip across the amplicon and then searching for the base in the dip region, and the proposed process of looking for the base across the amplicon and then computing the dip score at that position. We could also consider a framework where we do both analyses and take the one with the highest score. All the analyses can be rigorously evaluated with ROC analysis using true positive and negative data that we have and the additional true negative data we intend to obtain.

FIG. 8 shows the expected results for a Dip in local signal caused by variant. FIG. 8A shows a reduction in signal due to loss of hybridization and ligation as detected with forward strand probes only. All forward strand probes near the variant are shown and the text on the x-axis indicates how far the variant is from the center of the probe and how far it is from the 5′ end of the probe that is used for ligation. The y-axis shows the reduction in signal from the reference. In addition to a dip from hybridization loss that is greatest when the variant is in the center of the probe, there is a dip due to loss of ligation when the variant is near the 5′ ligation site. FIG. 8B shows a reduction in signal due to loss of hybridization and ligation as detected with reverse strand probes only. This is nearly a reverse image of panel A.

The detection of Indels poses a specific challenge. Indels 5 bp or larger are not enriched by MRD. Additionally, the array does not have probe relating to indel sequences. On the other hand the presence of an indel (especially more than 1 bp indel) leads to a more dramatic disruption of hybridization compared to when a mere mismatch is present. Since the detection by the enzymatic method does not entail having MM probes anyway, indels or mismatches become equivalent from that regard. Therefore the detection of small indels (3 bp or larger) is expected to be feasible since they are efficiently enriched by the bacteria and their effect on hybridization is large. Larger indels (5 bp or larger) are not enriched and hence their detection would be significantly more difficult.

Currently the base analysis does not consider any indels but rather focuses on calling the single base variation based on signals from MM probes. The base algorithm with the enzymatic reaction needs to consider indels in addition to the single base variation.

Concepts for scaling up the current methods are also disclosed. About 2% of the human genome (60 Mb) that would cover all the protein-coding exons as well as some other regions of interest like miRNA may be analyzed. Like we did in the design of the panel used in the preliminary results, a metatranscript for each gene is generated that contains all the protein-coding exons (+10 of the surrounding intronic regions) from all the gene's transcripts. An algorithm is then applied to ensure that exonic bases are covered in at least one of the three arrays. In the data described in the preliminary results section, 5% of the sequence is present on more than one array. This overlap can be helpful as a QC measure as well as a sample tracking check.

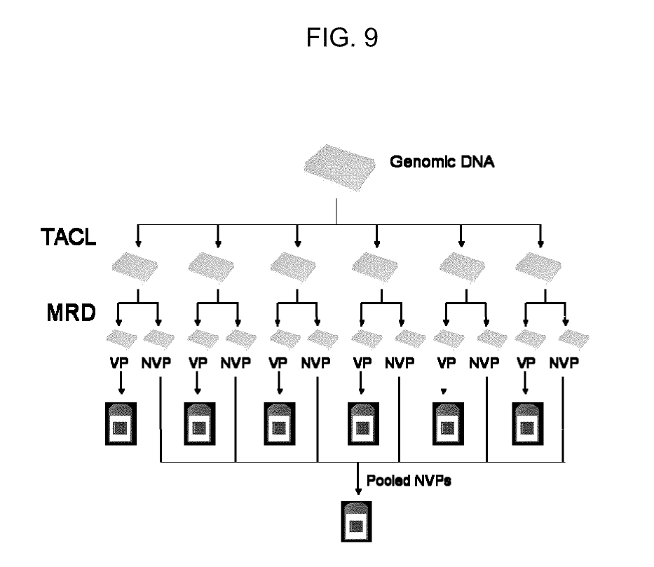

FIG. 9 shows a schematic for the process. A plate of genomic DNA can be split into 6 different plates. For each plate a different set of amplicons can be amplified by TACL. The TACL products are subjected to the MRD procedure generating VP and NVP. Each variant pool in each of the 6 plates is hybridized to an array (96 arrays used for each of the 6 plates). All 6 NVP corresponding to one individual are mixed together and applied to a single array. Overall, 6 TACL and MRD reactions are performed and 7 arrays are processed per genomic sample.

In a preferred aspect, about 360,000 amplicons may be designed to cover the 60 Mb of DNA. In addition to the total panel, arrays may be designed. In a preferred aspect 7 arrays would be designed for this study. Using the 4μ arrays, six arrays can cover 60 Mb. The seventh array would be used for the NVP. As discussed above the NVP is used to get the ratio level data and hence it is not necessary to have an array with a single base resolution. With one 4μ array, every amplicon of the 360,000 can have ˜30 features (half the amplicon will have 29 and the other half 30).

The oligo pools would be designed in batches of 10,000. Amplicons of similar sizes would be included in the same pool to minimize differences in oligo synthesis or later PCR amplification efficiency.

With each of the oligo pools an initial amplification will be performed using dUTP instead of dTTP. The resultant dUPs can be used to capture the sequences from the genomic DNA. The PCR product from this capture is then used to ligate into the MRD plasmid vector followed by transformation into a standard cloning strain. DNA is prepped from the transformants en masse, and this serves as an eternal reservoir of the panel. This is then transformed into the dam⁻ strain to prepare the needed amount of standard DNA.

A method for using TACL to normalize the concentration of the different sequences of oligo pools was described above. This method can be used to do the capture under conditions that promote normalization (more dUPs, longer hybridization time) to promote complete hybridization. The resulting normalized TACL material can then be cloned to make the standards and amplified using dUTP instead of dTTP to make the dUPs.

Alternatively, the initial amplifications can be used as the dUPs. A TACL may still be performed and the product of that used in making the standards as it is preferred to have the standard cover the full amplicon.

In a preferred embodiment, all the steps are done for 10,000 oligos at a time greatly reducing the required labor. For the transformations we would do 5-10 transformations per pool to ensure high number of representatives of each amplicon. There may be synthesis failure for some oligonucleotides. This can be readily detected by hybridizing the amplification products from the oligo pools onto the arrays. For these missing oligos, another oligo pool synthesis may be used. Approximately 5-10% of all amplicons may require the use of alternative enrichment schemes. In preferred aspects the panel is validated using a set of 30-50 HapMap samples. ROC curves can be generated describing false positive/false negative trade off as described above.

As feature size of arrays decreases to 1μ or 2μ distance from center to center larger amounts of data may be obtained. Arrays may be placed on a peg and laid out in a 96 well format. For example, each may have ˜36M and 9M features for 1 and 2 p arrays, respectively. In one 96 well format plate, using the 1, and 2μ arrays, all the protein-coding exons can be studied from 48, and 16 samples, respectively. This can lead to great reduction in cost and increase in throughput. Alternatively, more of the genome can be studied for the same cost.

These arrays may be used for resequencing. 1-2μ arrays that have the same content as the arrays may be used. The HapMap samples that were previously hybridized on the standard 5μ arrays can be hybridized to these smaller feature arrays.

In preferred aspects oligo pools may be used to make the panel instead of individual oligonucleotides. This decreases the cost of making the panel. Once the panel is constructed, the cost for using it in additional samples is relatively small.

Scalability of the TACL reaction with minimal reduction in efficiency has been demonstrated at 20,000 plex and it is expected that 60,000 to 100,000 should be similarly achievable with high efficiency. TACL is distinguished from some of the alternatives in that it combines the use of the efficient solution hybridization with enzymes leading to a highly specific and sensitive assay. The TACL reaction is robust and has already performed successfully.

In preferred aspects array hybridization combined with ligation reactions will be used to achieve accurate and scalable detection. Hybridization alone has been demonstrated to result in high quality data and the preliminary data obtained with the ligase suggests, as expected, that the data quality will be further improved by combining ligation and hybridization.

In some aspects arrays with 4μ features or smaller will be used. Larger feature sizes, for example 5μ may also be used. In some aspects a lower density of probes will be used. For example, for the NVP chip, 30 probes can be used per amplicon. Arrays have already been used in studies with 10,000 or more samples. This high throughput capacity distinguishes the array platform from some of the parallel sequencing technologies. Many of these platforms take several days to finish a single reaction and may not be very scalable. In contrast two array systems can run 10's of samples per day. In preferred aspects performance will be further enhance by the use of algorithmic and laboratory modifications to the current process.

In addition to overall performance there may be particular classes of variants that a specific technology is more likely to miss. The bacterial strain modification discussed above allows detection of all classes of single base mismatches uniformly. Deletions of 5 bases or larger as well as heterozygous variants in the presence of another homozygous variant in the same amplicon are difficult to detect since they are not enriched. A fraction of these would still be detected without the enrichment but certainly the efficiency is significantly lower. On the other hand, sequences that are highly similar over short stretches of DNA are difficult to analyze with short reads of parallel sequencing. They would also be difficult to identify the base change on the array. However, if the similar sequences are short so that the amplicon overall is unique, then our platform could detect the variant at least at the ratio level, i.e. we would detect a variant but not be able to identify the exact change.

In another aspect the number of probes on the resequencing array may be further decreased by using only mismatch probes. This method may also be combined with a ligation based approach or a primer extension approach to determine the identity of variant bases. This embodiment is related to the “dip” approach as discussed above. “Dips” and “peaks” in the hybridization pattern indicate changes from the wild type. Instead of using 8 probes for each interrogation position (4 per strand) or 4 probes (as in the alternating strand approach described above), in this embodiment the PM probes are not included.

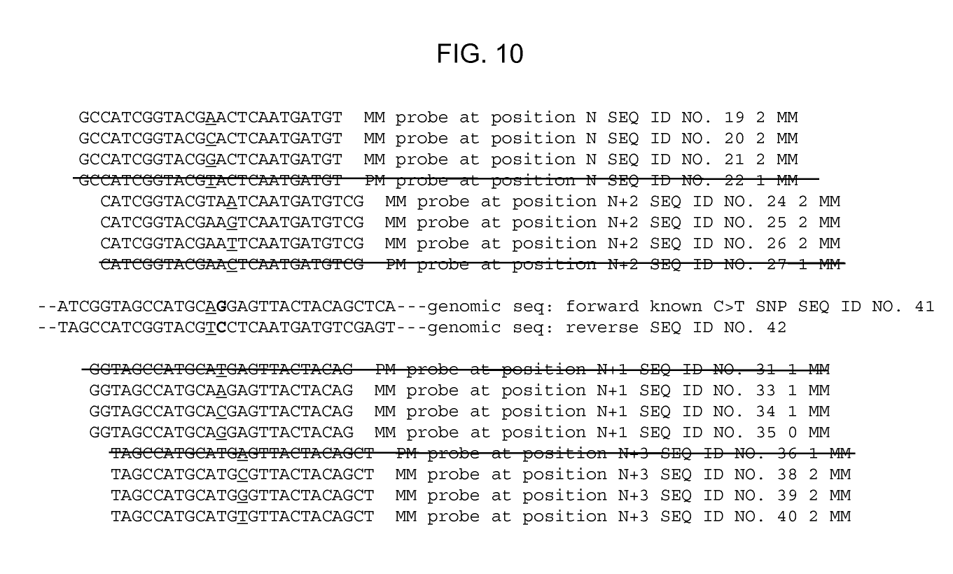

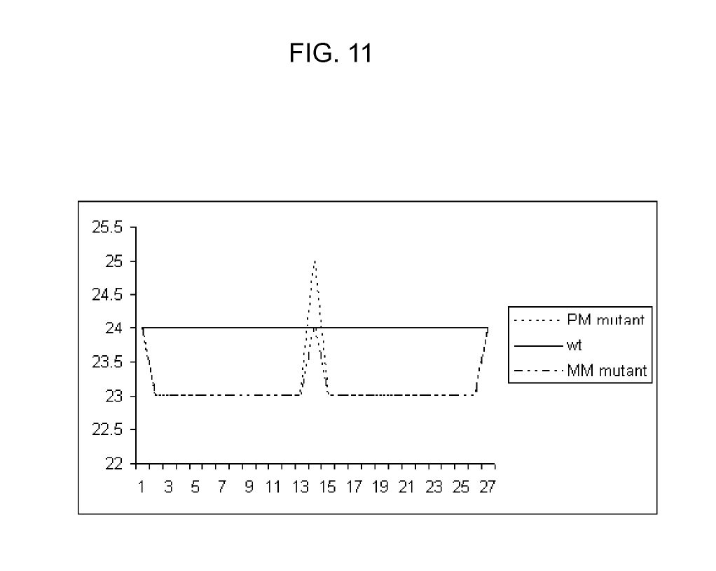

For example, if there is a variant at position N+1 in the target sequence shown in FIG. 5. The MM probes for positions N, N+2 and N+3 from FIG. 5A (now shown in FIG. 10) will have a second mismatch so they now have 2 MMs, as shown. The PM probes have a single MM. The probes for the N+1 position have either 1 mM or 0 mM for the probe that has the base that is complementary to the variant—the G probe in the example shown. The difference between the probes with 2 MMs and the probe with 0 mM is most dramatic. The results are graphically illustrated in FIG. 11 using only the MM probes. If the sequence is wild type each MM probe has a single mismatch and the hybridization of the probes is consistently at 24/25 bases. If there is a variant at position 13 the MM probes for the positions +/−12 from that position will have 2 mismatches and show a 23/25 pattern. The MM probes for that position will have either a single MM for 24/25 pattern (the two probes that are neither wild type or complementary to the variant base) or 0 mM for a 25/25 pattern for the probe that is complementary to the variant base. The PM probes are crossed off as they are not required for this analysis, just 3 mM probes for each position.

The pattern shows a disruption not just in the probe sets that interrogate the mutation position but also in the surrounding probe sets (+/−12). The impact being more dramatic the closer the mutation is to the interrogation position. Taking this into consideration you can reduce the number of probes from 4 (PM+3 mM) to 3 (3 mM) or even to a single MM.

For 3 probes you have only the 3 mismatch probes. All three will have about the same level of binding for the wild type but if there is a mutation present there will be a difference, but only for the probe set that is interrogating that position—the neighboring probe sets will have reduced binding around the mutation because they are complementary to the wt.

A single probe may also be used. The probe is one of the 3 possible mismatches, for example, if the wt base is an A the probe may be a G, C or A (not a T which would be the PM probe for the A). If there is a mutation at the interrogation position it can either be a perfect match to the probe or leave a single mismatch (wt is a mismatch and mutation to one of the other bases is a mismatch). If it is wt then there is a single mismatch in the interrogation probe and a single mismatch in the neighboring probes. If it is a mutation to another base there is a single mismatch in this probe but two mismatches in the surrounding probes. If the MM probe is the perfect match to the variant there are no MM's in that probe and 2 MM's in the surrounding probes.

In one aspect you have a single probe for each position and that probe has a mismatch at the central position so that it hybridizes to the wild type reference sequence with a single mismatch (24 of 25 bases complementarity). There are 3 bases that are possible other than the wt and the probe is complementary to only 1-if that mutation is present the probe will hybridize with complete complementarity (25/25). If either of the other two are present it will be like the wt (24/25). The surrounding probes provide additional information-they are also designed to be perfectly complementary to only a single variant but at a different position so if the wt is present at that position that is the central position of that probe and all the other bases are wt then it will hybridize with 24/25 bases. If there is a mutation in one of the other 24 positions there will be another mismatch so it will be 23/25. You could have then features leading up to a mutation that would have 23/25, then have 25/25 then go back to 23/25. This makes for a more dramatic difference between the interrogation position and the surrounding probe features. If the base is not wt but is one of the other two possible variants you see a 24/25 at the interrogation position which is the same as the wt but you also see the 23/25 at all the surrounding probes so you know there is a variant-you just don't know which of the other two it is. The wt is 24/25 at all positions—that is the baseline.

For example, if the wild type reference is an A and the most common variant is a G in place of the A—the probe would have a C. If the G is present the probe is 25/25 and the surrounding probes are 23/25. If the A is present you have 24/24 at the interrogation probe and the surrounding probes. If the base is a C or T you have 23/25 at all surrounding probes and 24/25 at the interrogation position. You can't distinguish readily between C and T at this point, but you can do SBE of a neighboring probe to determine the identity of that base.

TABLE 2

| | PM | | MM |
|---|---|---|---|
| position | mutant | wt | mutant |
| −1 | 24 | 24 | 24 |
| 1 | 23 | 24 | 23 |
| 2 | 23 | 24 | 23 |
| 3 | 23 | 24 | 23 |
| 4 | 23 | 24 | 23 |
| 5 | 23 | 24 | 23 |
| 6 | 23 | 24 | 23 |
| 7 | 23 | 24 | 23 |
| 8 | 23 | 24 | 23 |
| 9 | 23 | 24 | 23 |
| 10 | 23 | 24 | 23 |
| 11 | 23 | 24 | 23 |
| 12 | 23 | 24 | 23 |
| 13 | 25 | 24 | 24 |
| 14 | 23 | 24 | 23 |
| 15 | 23 | 24 | 23 |
| 16 | 23 | 24 | 23 |
| 17 | 23 | 24 | 23 |
| 18 | 23 | 24 | 23 |
| 19 | 23 | 24 | 23 |
| 20 | 23 | 24 | 23 |
| 21 | 23 | 24 | 23 |
| 22 | 23 | 24 | 23 |
| 23 | 23 | 24 | 23 |
| 24 | 23 | 24 | 23 |
| 25 | 23 | 24 | 23 |
| 1 | 24 | 24 | 24 |

The mutants are distinguished from the wt in the 23/25 footprint instead of 24/25. The PM mutant is distinguished from the MM mutant at the interrogation position—the MM mutant is 24/25 and the PM mutant is 25/25.

To figure out what base is present at the MM mutant a second analysis may be performed, for example, single base extension (SBE) or ligation based analysis. For SBE, for each hybridization interrogation position the SBE interrogation position is going to be the probe that terminates just 3′ of the interrogation position so that it can be extended by a single base that is the complement of the interrogation position. The SBE information would combine information from two probes—the probe that would give the SBE information would be the probe where the interrogation position is the next base immediately 3′ of the base at the end of the probe. The reaction would not be allele specific primer extension (ASPE) but straight SBE, wherein the base that is added is the base that is complementary to the polymorphic position and that based is determined.

If the results indicate that the single hybridization probe for the position you are interested in is a variant but not the perfect complement of the perfect mismatch probe then it is one of the other two bases and an SBE analysis using those two bases distinguishably labeled can be used to determine which base is present.

Each position has 25 probes that look at hybridization and a single probe that looks at SBE. The 25 probes each contain the position being interrogated—it moves from position 1 of the first probe to position 25 (at the 3′ end) of the last probe. The next probe over is the one that will interrogate by SBE—the position is just 5′ of the 3′ end of the probe. If the wt is A and the PM is G then the SBE distinguishes between A and C. Similarly, a ligation based approach can be used as described in U.S. patent application Ser. No. 11/874,848.

All patents, patent publications, and other published references mentioned herein are hereby incorporated by reference in their entireties as if each had been individually and specifically incorporated by reference herein. While preferred illustrative embodiments of the present invention are described, one skilled in the art will appreciate that the present invention may be practiced by other than the described embodiments, which are presented for purposes of illustration only and not by way of limitation.

1. A method for determining the location of one or more variants from a reference sequence in a target nucleic acid from a sample, said method comprising:
amplifying at least a portion of the target nucleic acid to obtain an amplification product;
labeling the amplification product with a detectable label to obtain a labeled amplification product;
hybridizing the labeled amplification product to an array comprising a mismatch probe set for each of a plurality of consecutive positions in a reference sequence, wherein each probe set consists of mismatch probes of length N that are perfectly complementary to the reference sequence at N−1 positions and contain a single mismatch position at an interrogation position, wherein said mismatch position is not complementary to the reference sequence but is perfectly complementary to a single possible variant at that position, thereby obtaining a hybridization signal for a plurality of mismatch probes;
analyzing the hybridization signals to identify a hybridization pattern over a plurality of probe sets having consecutive interrogation positions where the hybridization signal varies from the signal expected for a target nucleic acid that does not contain one or more variants; and,
determining the location of one or more variants from the hybridization pattern.

2. The method of claim 1 wherein each mismatch probe set consists of a single mismatch probe that is complementary at the interrogation position to a single selected variant one of three possible variants, but not complementary to the other two possible variants and not complementary to the reference sequence at the interrogation position.

3. The method of claim 1 wherein the probe length N is 20 to 30 bases and the interrogation position is at a central position.

4. The method of claim 1 wherein the step of amplifying comprises target amplification by capture ligation.

5. The method of claim 1 wherein the array comprises probe sets for a plurality of reference sequences, each reference sequence being an exonic region of a gene and wherein targets are amplified using TACL and variant sequences are first enriched using mismatch repair detection.

6. The method of claim 2 wherein there is a first expected pattern for a region of the target containing no variants from the reference sequence, a second expected pattern for a region of the target sequence containing a single variant that is not complementary to the interrogation position of the mismatch probe and a third expected pattern for a region that contains a single variant that is complementary to the interrogation position of the mismatch probe.

7. The method of claim 6 wherein if the second expected pattern is observed the base is identified as one of the two possible non-complementary variants.

8. The method of claim 6 wherein if the third expected pattern is observed the base is identified as the complementary variant.

9. The method of claim 7 wherein a subsequent reaction is used to determine the base present at the variant.

10. The method of claim 9 wherein said reaction is a single base extension of a probe immediately adjacent to the interrogation region.

11. The method of claim 1 wherein said determining comprises comparing the hybridization pattern to a reference hybridization pattern from the reference sequence to identify differences in the hybridization pattern that span multiple probes corresponding to contiguous interrogation positions in the reference sequence, thereby defining a variant detection region corresponding to a region of length N in the target that contains a variant position.

12. The method of claim 11 where the hybridization pattern is further analyzed to identify the base corresponding to the variant by identifying the probe within the variant detection region that has a hybridization intensity that is different from the hybridization intensity of the other probes in the variant detection region.

13. The method of claim 12 further comprising identifying the base as the perfect match of one of the mismatch probes and identifying the base as corresponding to the interrogation position of that mismatch probe or identifying the base as one of the other two non-reference bases.

14. A method for detecting in a target sequence of a single base variant from a reference sequence, said method comprising:
amplifying at least a portion of the target sequence to obtain an amplification product and hybridizing the amplification product to an array of probes to obtain a hybridization pattern comprising hybridization intensities for individual probes;
wherein said array of probes comprises a plurality of probe sets each probe set consisting of 1 or 3 probes that have a single mismatch to a reference sequence at a central position, but are otherwise perfectly complementary over the length of the probe to the reference sequence;
obtaining a reference hybridization pattern comprising hybridization intensities for individual probes to the reference sequence;
analyzing the hybridization pattern of the target sequence to identify regions of the target sequence that have hybridization intensities that vary from the reference hybridization pattern over a plurality of probes that interrogate a contiguous region of the target sequence; and,
determining that a single base variant is present in the target sequence.

15. The method of claim 14 wherein each probe set consists of 3 probes.

16. The method of claim 14 wherein each probe set consists of 1 mismatch probe and further comprising determining what base is present at said single base variant by determining that the target is perfectly complementary to the mismatch probe having interrogation position at the variant position or by determining that one of the other two bases is present and using a secondary method to determine which base is present.

17. The method of claim 15 further comprising determining the base present at the variant position by identifying the mismatch probe that is the perfect complement to the variant at the interrogation position.

18. The method of claim 16 wherein a plurality of the mismatch probes are selected to be perfect match probes for a common variant at the interrogation position of that probe.

19. A resequencing array comprising a plurality of mismatch probe sets:
wherein the array comprises a mismatch probe set for each base in a reference sequence to be analyzed for variants;
wherein each mismatch probe set consists of 3 perfect match variant probes, wherein each perfect match variant probe is perfectly complementary to the reference sequence over the length of the probe except for a single central mismatch position that is complementary to one of the three possible variants from the reference sequences and wherein each perfect match variant probe is complementary to a different possible variant so that there is a perfect match variant probe for each possible variant.

20. The array of claim 19 wherein the reference sequence is at least 50 bases in length and the array comprises a mismatch probe set for each base of the reference sequence.
